(19) United States
(12) Patent Application Publication
(10) Pub. No.: US 2017/0256238 A1
(43) Pub. Date: Sep. 7, 2017

(54) METHOD AND APPARATUS FOR CONTENT DISPLAY

(71) Applicant: Lenovo (Beijing) Limited, Beijing (CN)

(72) Inventors: Xiaotian Zhu, Beijing (CN); Zhixiang Wang, Beijing (CN); Jie Xia, Beijing (CN); Sheng Yang, Beijing (CN); Guanchen Yang, Beijing (CN)

(21) Appl. No.: 15/452,464

(22) Filed: Mar. 7, 2017

(30) Foreign Application Priority Data
Mar. 7, 2016 (CN) 201610128395.2

(51) Int. Cl. G09G 5/32; G06F 3/01; G06F 3/0484; G06F 1/16

(52) U.S. Cl. CPC G09G 5/32; G06F 1/163; G06F 3/011; G06F 3/0484; G09G 2380/02; G09G 2340/0464; G06F 2203/04803

(57) ABSTRACT

A method and an apparatus are disclosed. The method includes obtaining content, displaying a first portion of content in a first region of a display while maintaining the first display ratio of the first portion of content, and displaying a second portion of content in a second region of the display while maintaining the second display ratio of the second portion of content. The apparatus includes a processor that obtains content to be displayed, wherein the content includes a first portion of content having a first display ratio, and a second portion of content having a second display ratio and the processor maintains the display ratios of the first portion of content and the second portion of content; and a display module that includes multiple regions to display the content.

### FIELD

The present disclosure relates to a display method and apparatus, and in particular to a display method and apparatus capable of reducing display distortion conditions of a non-standard ratio screen.

### BACKGROUND

With the widespread popularity of electronic products and touchscreen interfaces, certain aspect ratios of screens of such electronic products have been developed. Many applications run on such electronic products are also based on such aspect ratios. However, when electronic devices having screens of other aspect ratios run such applications, screen display distortion occurs.

### SUMMARY

Embodiments of a method and an apparatus are disclosed.

The method includes: obtaining content to be displayed, the content comprising a first portion of content having a first display ratio and a second portion of content having a second display ratio; displaying the first portion of content in a first region of a display unit whilst maintaining the first display ratio of the first portion of content; and displaying the second portion of content in a second region of the display unit whilst maintaining the second display ratio of the second portion of content.

The apparatus includes: a processor configured to obtain content to be displayed, the content comprising a first portion of content having a first display ratio and a second portion of content having a second display ratio; and a display module comprising a plurality of regions to display the content; wherein the processor is configured to display the first portion of content in a first region of the display module whilst maintaining the first display ratio of the first portion of content, and to display the second portion of content in a second region of the display module whilst maintaining the second display ratio of the second portion of content.

### BRIEF DESCRIPTION OF THE DRAWINGS

The foregoing and other objects, features and advantages of the present disclosure will become more apparent from the detailed descriptions of the embodiments of the present disclosure in conjunction with the drawings. The drawings are used to provide a further understanding of the embodiments of the present disclosure and constitute a part of the Description, which, together with the embodiments of the present disclosure, serve to explain the present disclosure and are not construed as a limitation to the present disclosure. Unless explicitly indicated, the drawings should not be understood as being drawn to scale. In the drawings, the same reference numerals generally represent the same components or steps. In the drawings:

FIG. 1 is a flow diagram of one embodiment of a display method;

FIG. 2 is a diagram schematically illustrating a one embodiment of a display unit of an electronic device;

FIG. 3 is a diagram schematically illustrating one embodiment of a display unit of an electronic device applied in a display method;

FIG. 4 is a diagram schematically illustrating one embodiment of a display unit of yet another electronic device;

FIG. 5 is a configuration block diagram of one embodiment of an electronic device; and

FIG. 6 is a configuration block diagram of one embodiment of an electronic device.

### DETAILED DESCRIPTION

To make the objects, technical solutions and advantages of the present disclosure more apparent, exemplary embodiments of the present disclosure will be described in detail with reference to the drawings. It is obvious that the described embodiments are merely some of, rather than all, the embodiments of the present disclosure, and it should be understood that the present disclosure is not limited to the exemplary embodiments described herein. Based on the embodiments described herein, all other embodiments obtained by those skilled in the art without inventive skills shall fall within the protection scope of the present disclosure. In the description and drawings, the same reference numerals will be employed to represent substantially the same elements and functions, and repeated descriptions of these elements and functions will be omitted. In addition, descriptions of functions and constructions that are well known in the art can be omitted for clarity and conciseness.

A display method of an embodiment of the present disclosure will be described in detail with reference to the drawings.

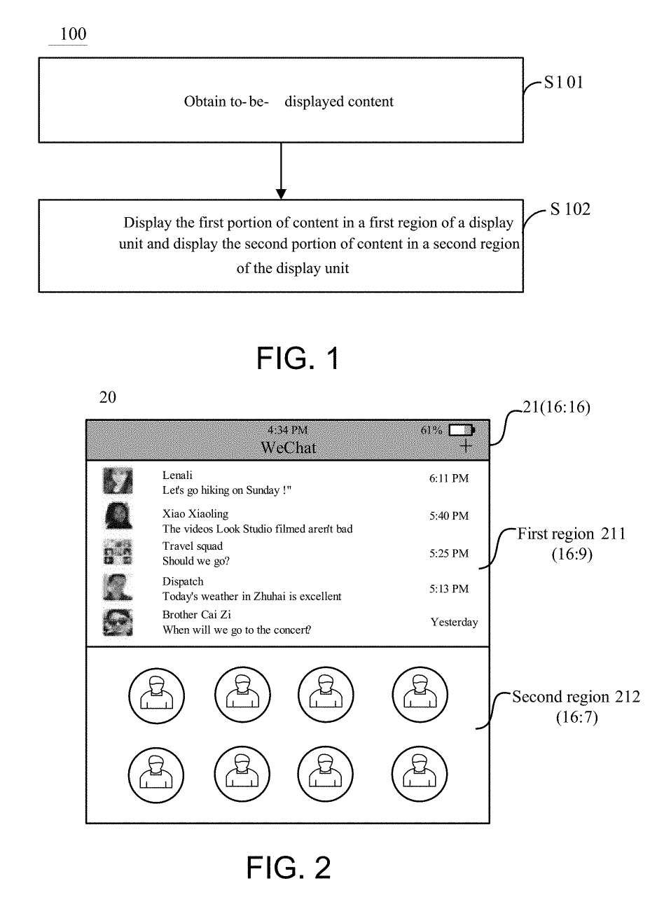

FIG. 1 is a flow diagram of one embodiment of a display method. The display method 100 according to one embodiment of the present disclosure may be applied to electronic devices, such as desktops, laptop computers, tablet computers, smartphones, personal digital assistants, wearable smart devices and the like. Hereinafter, for ease of description, a smartphone will be taken as an example of such electronic devices. Thus, “smartphone” described hereinafter should be understood as an illustrative expression of an electronic device applied by the display method 100 of the present disclosure, and should not be construed as a limitation to the electronic device applied by the display method 100 of the present disclosure. As is well known to those skilled in the art, a smartphone comprises components such as a display unit, a control unit, and the like.

As shown in FIG. 1, the display method 100 comprises the following steps S101 and S102.

In step S101, to-be-displayed content is obtained, wherein the to-be-displayed content comprises a first portion of content and a second portion of content.

The to-be-displayed content is content to be displayed on a display unit of a smartphone. The to-be-displayed content may come from the smartphone itself. For example, the smartphone may play video and audio files in the smartphone memory through a built-in video player. The to-be-displayed content may also come from other devices external to the smartphone. For example, the smartphone may enable viewing of online videos by using a browser through a Wi-Fi connection.

The to-be-displayed content comprises a first portion of content and a second portion of content. The first portion of content and the second portion of content may come from the same source. For example, the first and second portions of content may both come from the smartphone itself. In such a case, the first portion of content may be a player interface of a video player that is pre-installed in the smartphone, and the second portion of content may be a display interface of an instant messaging tool (such as WeChat) or another application installed in the smartphone. The first portion of content and the second portion of content may also come from different sources. For example, the first portion of content may be content of an instant messaging tool that is pre-installed in the smartphone, while the second portion of content may be a player interface of an online video viewed through a browser by the smartphone.

Although the first portion of content and the second portion of content are exemplarily illustrated above, the present disclosure is not limited thereto. Those skilled in the art could, based on actual requirements, selectively set the first portion of content and the second portion of content, so long as principles of the present disclosure can be realized. The first portion of content and the second portion of content will be further illustrated in conjunction with specific examples later.

In step S102 of some embodiments, the first portion of content is displayed in a first region of a display unit, and the second portion of content is displayed in a second region of the display unit, wherein the first region and the second region do not overlap with each other, a display ratio of the first region is the same as that of the first portion of content, a display ratio of the second region is the same as that of the second portion of content, and the display ratio of the first portion of content is different from that of the display unit.

It should be noted that the display ratio of the first portion of content of the present disclosure is predetermined, and the predetermined display ratio can generally be preset by a developer of the first portion of content so as to be fixed in display attributes of the first portion of content. Alternatively, it can also be an optimal display ratio determined by the first portion of content according to hardware configurations of the smartphone. Therefore, although the dimension of the first portion of content can be scaled, the first portion of content cannot match the entire display unit of the smartphone by the scaling since the display ratio of the first portion of content is different from that of the display unit.

The display method 100 will be described in detail in conjunction with FIG. 2 to FIG. 4 hereinafter.

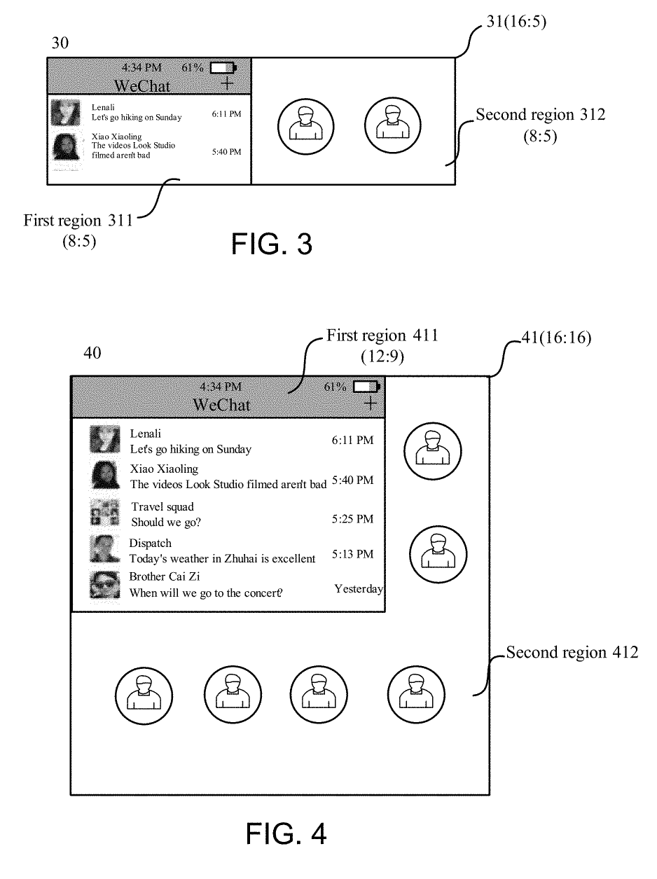

FIG. 2 is a diagram schematically illustrating one embodiment of a display unit of an electronic device, and illustrates a display unit 21 of a smartphone 20 according to an embodiment of the present disclosure. FIG. 3 is a diagram schematically illustrating one embodiment of a display unit of an electronic device and depicts a display unit 31 of a smartphone 30 according to an embodiment of the present disclosure.

A description is first made in conjunction with FIG. 2. As shown in FIG. 2, the display ratio of the display unit 21 is 16:16, that is, a display unit of the smartphone 20 is square. It should be noted that defining the display ratio of the display unit 21 as 16:16 herein is only for ease of comparison and illustration of display ratios of the display unit and of respective regions hereinafter. In practice, the display ratio of a non-standard ratio display unit may also be represented in the form of 1:1 and the like.

Assuming a situation as shown in FIG. 2 in which a standard display ratio of the display unit is defined as 16:9, and assuming that display ratio of an interface of a particular application displayed on the display unit 21 of the smartphone 20 is the same as the defined standard display ratio (that is, the display ratio of the interface of the particular application is also 16:9), it can be known that the display ratio of the display unit 21 of the smartphone 20 is not a standard display ratio. Therefore, when the particular application is run on the smartphone 20, a problem occurs in that the display ratio (16:9) of the interface of the particular application is not matched with the display ratio (16:16) of the display unit 21, which leads to the occurrence of twisting, scaling and even distortion conditions of the interface of the particular application.

In the situation as shown in FIG. 2, WeChat is taken as an example of the above-described particular application. In step S101, the obtained first portion of content is a display interface of the WeChat application, and the obtained second portion of content is a display interface of an address book. In order to obtain the display interface of WeChat and the display interface of the address book in step S101, a user may operate to initiate the WeChat application and open the address book.

As shown in FIG. 2, in step S102, the display interface of WeChat is displayed in a first region 211 of the display unit 21, and the display interface of the address book is displayed in a second region 212 of the display unit 21.

The first region 211 and the second region 212 do not overlap with each other. As shown in FIG. 2, the first region 211 is located above the second region 212. A display ratio of the first region 211 is the same as that of the first portion of content (that is, the display interface of WeChat); both are 16:9. A display ratio of the second region 212 is the same as that of the second portion of content (that is, the display interface of the address book); both are 16:7. The display ratio (16:9) of the first portion of content is different from the display ratio (16:7) of the display unit 21.

One advantage of the situation shown in FIG. 2 is that, in regard to a screen of a non-standard display ratio, the displaying of the first portion of content in a standard display ratio can be ensured so as to avoid the occurrence of conditions such as twisting, deformation and distortion of the particular application during display, and the area of the first region 211 can also be reduced appropriately. As described above, since the first region 211 displays an interface of a particular application such as a video player, WeChat, or other application, appropriately reducing the area of the first region is advantageous for saving computing resources of the smartphone, thereby saving power. Further, in the situation shown in FIG. 2, the second region 212 is disposed external to the first region 211. Therefore, the second portion of content, such as the address book, can be displayed in the second region 212, such that more types of content can be displayed on the display unit 21 for users, facilitating prompts to the user and improving user experience of a non-standard ratio screen.

Moreover, the situation shown in FIG. 2 offers further advantages. On the one hand, in developing an application such as WeChat as shown in FIG. 2, customized development of display of the application is not required; that is, the display ratio of the application is not required to be customized to accommodate the non-standard ratio screen. Instead, the application only needs to be displayed in a standard display ratio or in a general display ratio. On the other hand, it may not be necessary for a manufacturer of a mobile electronic device such as a smartphone to limit a display screen of the mobile electronic device to a standard ratio screen. Therefore, the display method of the present disclosure is more advantageous for popularity and use of an application having a general display ratio on a device having a screen of a special display ratio.

Although in FIG. 2 a positional relationship between the first region 211 and the second region 212 is shown as the first region 211 and the second region 212 being arranged in a sequential manner from an upper end to a lower end of the display unit 21, the present disclosure is not limited thereto. In step S102, the second region 212 and the first region 211 can also be arranged in a sequential manner from the upper end to the lower end of the display unit 21. In addition, in step S102, the first region 211 can also be disposed in a middle region of the display unit 21, so that the first region 211 is divided into two sub-regions (a first sub-region and a second sub-region) and the two sub-regions are disposed in an upper portion and a lower portion of the first region 211, respectively. Hence, in such a situation, the first sub-region, the first region 211 and the second sub-region are arranged in a sequential manner from the upper end to the lower end of the display unit 21.

Although in the example described above with reference to FIG. 2, the standard display ratio is defined as 16:9 and display ratio of an interface of a particular application such as WeChat is set to be the same as the standard display ratio, it is known to those skilled in the art that a variety of standard display ratios may be used. For example, consider the ratio of 4:3. Still taking the above situation shown in FIG. 2 as an example, if the standard display ratio and the display ratio of the display interface of WeChat are set to 4:3 (i.e., 16:12), then in step S102, the display ratio of the first region 211 is the same as that of the display interface of WeChat (both are 16:12) and the display ratio of the second region 212 is the same as that of the display interface of the address book (both are 16:4).

A description is made in conjunction with FIG. 3 hereinafter. As shown in FIG. 3, in one embodiment the display ratio of a display unit 31 is 16:5. That is to say, the display unit of a smartphone 30 is elongated, strip-like and rectangular. It should be noted that, defining the display ratio of the display unit 31 herein as 16:5 is only for ease of comparison and illustration of display ratios of the display unit and of the individual regions hereinafter. For example, in practice, display ratio of a non-standard ratio display unit may also be represented by any other appropriate ratio formulas.

Assuming a situation as shown in FIG. 3 in which a standard display ratio of the display unit is defined as 16:10, and assuming that display ratio of an interface of a particular application displayed on the display unit 31 of the smartphone 30 is the same as the defined standard display ratio (that is, the display ratio of the interface of the particular application is also 16:10), it can be known that the display ratio of the display unit 31 of the smartphone 30 is not a standard display ratio. Therefore, when the particular application is run on the smartphone 30, the display ratio (16:10) of the interface of the particular application is not matched with the display ratio (16:5) of the display unit 31, which leads to the occurrence of twisting, scaling and even distortion conditions in the interface of the particular application.

In the situation shown in FIG. 3, WeChat is still taken as an example of the above-described particular application. In step S101, the obtained first portion of content is a display interface of WeChat application, and the obtained second portion of content is a display interface of an address book. In order to obtain the display interface of WeChat and the display interface of the address book in step S101, a user may operate to initiate the WeChat application and to open the address book.

As shown in FIG. 3, in step S102, the display interface of WeChat is displayed in a first region 311 of the display unit 31, and the display interface of the address book is displayed in a second region 312 of the display unit 31.

The first region 311 and the second region 312 do not overlap with each other. As shown in FIG. 3, the first region 311 is located at a left side of the second region 312. A display ratio of the first region 311 is the same as that of the first portion of content (i.e., the display interface of WeChat), and both are 16:10 (i.e., 8:5). The display ratio of the second region 312 is the same as that of the second portion of content (i.e., the display interface of the address book), and both are 16:10 (i.e., 8:5), and the display ratio (16:10) of the first portion of content is different from the display ratio (16:5) of the display unit 31.

An advantage of the situation shown in FIG. 3 is that, in regard to a screen of a non-standard display ratio, the display of the first portion of content in a standard display ratio can be ensured so as to avoid the occurrence of conditions such as twisting, deformation and distortion and the like of the particular application during display, and the area of the first region 311 can also be reduced appropriately. As described above, the first region 311 displays an interface of a particular application such as a video player and WeChat and the like. Thus, appropriately reducing the area of the first region is advantageous for saving computing resources of the smartphone, thereby saving power. Further, in the situation shown in FIG. 3, the second region 312 is disposed external to the first region 311. Therefore, the second portion of content, such as the address book, can be displayed in the second region 312, such that more types of content can be displayed on the display unit 31 for users, facilitating prompting the user and improving user experience of a screen of a non-standard display ratio.

Although in FIG. 3, a positional relationship between the first region 311 and the second region 312 is shown (wherein the first region 311 and the second region 312 are arranged in a sequential manner from a left end to a right end of the display unit 31), the present disclosure is not limited thereto. In step S102, the second region 312 and the first region 311 can also be arranged in a sequential manner from the left end to the right end of the display unit 31. In addition, in step S102, the first region 311 can also be disposed in a middle region of the display unit 31, so that the second region 312 is divided into two sub-regions (a third sub-region and a fourth sub-region) and the two sub-regions are disposed at a left side and a right side of the second region 312, respectively. Hence, in such a situation, the first sub-region, the second region 312 and the second sub-region are arranged in a sequential manner from the left end to the right end of the display unit 31.

A description is made in conjunction with FIG. 4 hereinafter. A display unit 41 shown in FIG. 4 is similar to the display unit 21 shown above in conjunction with FIG. 2. The display ratio of the display unit 41 is 16:16, that is, a display unit of a smartphone 40 is square.

Assuming a situation as shown in FIG. 4 in which a standard display ratio of the display unit is defined as 4:3, and assuming that a display ratio of an interface of a particular application displayed on the display unit 41 of the smartphone 40 is the same as the defined standard display ratio, the display ratio of the interface of the particular application is also 4:3, it can be known that the display ratio of the display unit 41 of the smartphone 40 is not a standard display ratio. Therefore, when the particular application is run on the smartphone 40, the display ratio (4:3) of the interface of the particular application is not matched with the display ratio (16:16) of the display unit 41, which leads to the occurrence of twisting, scaling and even distortion conditions in the interface of the particular application.

In the situation shown in FIG. 4, WeChat is again taken as an example of the above-described particular application. In step S101, the obtained first portion of content is a display interface of the WeChat application, and the obtained second portion of content is a display interface of an address book.

As shown in FIG. 4, in step S102, the display interface of WeChat is displayed in a first region 411 of the display unit 41, and the display interface of the address book is displayed in a second region 412 of the display unit 41.

The first region 411 and the second region 412 do not overlap with each other. A display ratio of the first region 411 is the same as that of the first portion of content (i.e., the display interface of WeChat), and both are 4:3; a display ratio of the second region 412 is the same as that of the second portion of content (i.e., the display interface of the address book), and the display ratio (4:3) of the first portion of content is different from the display ratio (16:16) of the display unit 41. In the situations described above in conjunction with FIG. 2 and FIG. 3, the first region and the second region only have one common edge. In contrast, in the situation shown in FIG. 4, the first region 411 and the second region 412 have two common edges, that is, the first region 411 is located at an upper left side of the second region 412.

An advantage of the situation shown in FIG. 4 is that the displaying of the first portion of content in a standard display ratio can be ensured, and the area of the first region can also be appropriately reduced. As described above, the first region 411 displays an interface of a particular application such as a video player, WeChat and the like. Thus, appropriately reducing the area of the first region is advantageous for saving computing resources of the smartphone, thereby saving power. Moreover, in the situation shown in FIG. 4, the area of the second region 412 is appropriately enlarged, and a greater amount of content can be displayed, and can be better provided to the user.

In the situation shown in FIG. 4, in step S102, the user can adjust the area of the first region 411, to realize equalization of content information between the first portion of content and the second portion of content by adjusting the area of the first region 411. For example, in the situation shown in FIG. 4, assuming that the user views a video through the first region 411 and browses a webpage through the second region 412, if the user's demand for video content is slight (for example, only sounds are required to be played) while the user's demand for webpage content is great, then the user may approximately reduce the area of the first region 411 so as to enlarge the area of the second region 422. Thus, the user experience in the situation shown in FIG. 4 can be further improved.

Although in FIG. 4 a positional relationship between the first region 411 and the second region 412 is shown (wherein the first region 411 is located at an upper left side of the second region 412), the present disclosure is not limited thereto. In step S102, the second region 412 can also be disposed at an upper right side, a lower right side or a lower left side, etc., of the first region 411. In addition, in step S102, the first region 411 can also be disposed in a middle region of the display unit 21, so that the second region 211 is divided into a plurality of sub-regions, and the plurality of sub-regions are disposed around the first region 211, respectively.

Although in the several examples described above with reference to FIG. 2 to FIG. 4, the standard display ratios are exemplarily illustrated as 4:3, 16:9 and 16:10, the present disclosure is not limited thereto. Those skilled in the art could, based on actual requirements, selectively set the standard display ratio, so long as principles of the present disclosure can be realized.

Further, although in the several examples described above with reference to FIG. 2 to FIG. 4, the first regions 211, 311 and 411 are illustrated as a quadrilateral, the present disclosure is not limited thereto. The first region may also be polygonal or of other irregular shapes.

Although in the above various examples, the display interface of WeChat is used as the first portion of content and the display interface of the address book is used as a second portion of content, the present disclosure is not limited thereto. Those skilled in the art could, based on actual requirements, selectively set the first portion of content and the second portion of content, as long as principles of the present disclosure can be realized.

In some embodiments, after step S101, the display method 100 further comprises the following steps of: obtaining display ratio of the display unit and obtaining display ratio of the first portion of content; and determining the first region based on the display ratio of the display unit and the display ratio of the first portion of content.

The display ratio of the display unit can be set during factory manufacturing of the display unit, and is then read by the smartphone in the display method 100. The display ratio of the display unit can also be acquired based on user's operations. For instance, the display ratio of the display unit of the smartphone can be manually input by the user when the smartphone executes the display method 100. Although different methods for obtaining the display ratio of the display unit are illustrated above, the present disclosure is not limited thereto. Those skilled in the art could, based on actual requirements, select the implementation for obtaining the display ratio of the display unit, as long as principles of the present disclosure can be realized.

A display ratio of the first portion of content may be a default display ratio and preset in a smartphone. For example, applications such as a video player and an instant messaging tool may employ a general display ratio known in the art as a default display ratio, whereby the general display ratio may be directly employed in performing the display method 100. In some embodiments, the display ratio of the first portion of content can also be set by the user. For example, the user may, based on his/her own operating habits, manually set the display ratio of the first portion of content. Although different methods for obtaining the display ratio of the first portion of content are illustrated above, the present disclosure is not limited thereto. Those skilled in the art could, based on actual requirements, select the implementation for obtaining the display ratio of the first portion of content, as long as principles of the present disclosure can be realized.

In some embodiments, the processing for determining the first region based on the display ratio of the display unit and the display ratio of the first portion of content comprises the following: if the display ratio of the first portion of content is greater than that of the display unit, a long edge of the first region will coincide with a long edge of the display unit; and if the display ratio of the first portion of content is smaller than that of the display unit, a short edge will coincide with a short edge of the display unit.

The above-described processing for determining the first region is illustrated below with reference to FIG. 2 and FIG. 3.

As shown in FIG. 2, the display ratio of the display unit 21 is 16:16 and the display ratio of the first portion of content is 16:9, and thus it can be determined that the display ratio of the first portion of content is greater than the display ratio of the display unit 21. In the situation shown in FIG. 2, in determining the first region 211, a long edge of the first region 211 is configured to be coincident with any one of the edges of the display unit 21. After determining the long edge of the first region 211, the length of a short edge of the first region 211 can be determined based on the display ratio of the first portion of content. The first region 211 is thus determined.

As shown in FIG. 3, the display ratio of the display unit 31 is 16:5 and the display ratio of the first portion of content is 16:10, and thus it can be determined that the display ratio of the first portion of content is smaller than the display ratio of the display unit 31. In the situation shown in FIG. 3, in determining the first region 311, a short edge of the first region 311 is configured to be coincident with a short edge of the display unit 31. After determining the short edge of the first region 311, the length of the long edge of the first region 311 can be determined based on the display ratio of the first portion of content. The first region 311 is thus determined.

Although the method of determining the first region is exemplarily illustrated above with reference to FIG. 2 and FIG. 3, the present disclosure is not limited thereto. Those skilled in the art could, based on actual requirements, employ any appropriate methods to determine the first region, as long as principles of the present disclosure can be realized.

In some embodiments, step S102, the step of displaying the first portion of content in the first region of the display unit, comprises the following: processing the first portion of content in a first processing manner if the display ratio of the first portion of content is greater than that of the display unit; and processing the first portion of content in a second processing manner if the display ratio of the first portion of content is smaller than that of the display unit, wherein the first processing manner is different from the second processing manner.

The above-described processing of the first portion of content by employing the first processing manner or the second processing manner is similar to the processing for determining the first region as described with reference to FIG. 2 and FIG. 3. The first processing manner and the second processing manner will be illustrated in conjunction with FIG. 2 and FIG. 3.

As shown in FIG. 2, the display ratio of the display unit 21 is 16:16 and the display ratio of the interface of WeChat is 16:9, and thus it can be determined that the display ratio of the interface of WeChat is greater than the display ratio of the display unit 21. In this situation, the first processing manner may configure a long edge of the interface of WeChat to be coincident with any one of the edges of the display unit 21, and determine the length of a short edge of the interface of WeChat based on the display ratio of the interface of WeChat and the long edge of the interface of WeChat.

Although FIG. 2 exemplarily illustrates the first processing manner, the present disclosure is not limited thereto. For instance, the first processing method may also adjust the dimension of the first portion of content in the display unit 21 based on the long edge of the first portion of content and the display ratio thereof.

As shown in FIG. 3, the display ratio of the display unit 31 is 16:5 and the display ratio of the interface of WeChat is 16:10, and thus it can be determined that the display ratio of the interface of WeChat is smaller than the display ratio of the display unit 31. In this situation, the second processing manner may configure the short edge of the interface of WeChat to be coincident with the short edge of the display unit 31, and determine the length of the long edge of the interface of WeChat based on the display ratio of the interface of WeChat and the short edge of the interface of WeChat.

Although FIG. 3 exemplarily illustrates the second processing manner, the present disclosure is not limited thereto. For instance, the second processing method may also adjust the dimension of the first portion of content in the display unit 21 based on the short edge of the first portion of content and the display ratio thereof.

It is noted that the above-described step of obtaining the display ratio of the display unit and obtaining the display ratio of the first portion of content after step S101 can occur before step S102, or can be incorporated into step S102.

In some embodiments, step S101 may also comprise: obtaining an interface of a first application and using the interface of the first application as the first portion of content, and determining the second portion of content based on the first application.

A description will be made still in conjunction with FIG. 2 hereinafter. As shown in FIG. 2, a first application is WeChat and an interface of the first application is an interface of WeChat, and thus the interface of WeChat is used as the first portion of content. The second portion of content is an interface of an address book, wherein the interface of the address book is determined according to WeChat. In other words, content in the interface of the address book is determined according to WeChat. Specifically, as shown in FIG. 2, the interface of WeChat displays several WeChat friends “Lenali”, “Xiao Xiaoling”, “Da Fa” and so on. Accordingly, contact addresses of the several contacts of “Lenali”, “Xiao Xiaoling” and “Da Fa” and so on are correspondingly displayed in the interface of the address book. Additionally, in the situation shown in FIG. 2, when a WeChat friend list displayed in the interface of WeChat is changed, the contacts displayed in the interface of the address book are also changed, and the friends in the WeChat friend list correspond to the contacts in the interface of the address book. The advantage of doing so is that WeChat and the address book can be associated with each other to better prompt a user, and if a user wants to make a phone call after seeing a message of a certain WeChat friend, the user may select the contact directly from the interface of the address book and make a phone call, thereby improving user experience.

In some embodiments, in step S102, displaying the second portion of content may further comprise: determining an application displayed in the first region, selecting a corresponding second portion of content based on a predetermined matching relationship, and displaying the second portion of content.

Taking the situation shown in FIG. 2 as an example, it is assumed that a predetermined matching relationship exists between WeChat and the address book. In step S102, when it is determined that the application displayed in the first region is WeChat, the interface of the address book is displayed in the second region based on the predetermined matching relationship.

The predetermined matching relationship can be preset in a smartphone during factory manufacturing of the smartphone, and can also be set by a user based on his/her own daily usage habits. Those skilled in the art could also, based on any other appropriate manners, set the predetermined matching relationship, as long as principles of the present disclosure can be realized.

In some embodiments, the step of determining the application displayed in the first region may comprise: detecting an application that is currently activated or detecting an application that is switched to a display state.

Still taking the situation shown in FIG. 2 as an example, the smartphone may detect the application that is currently activated, or may detect the application that is switched to the display state. For example, the smartphone may detect an application icon displayed on the display unit of the smartphone based on the user, and if it is detected that the user clicks a certain application icon (for example, a WeChat icon), then it is detected that the currently activated application is WeChat (this can also be determined through process detection). As another example, the smartphone may detect the user's display switching operation (for example, a click operation on a virtual switch key on the display unit by the user). If the user's display switching operation is detected, then an object of the display switching operation is detected as the application that is switched to the display state (that is, detecting an application corresponding to a process that is in a foreground display state after switching). Although several ways for determining the application displayed in the first region are exemplarily illustrated above, the present disclosure is not limited thereto. Those skilled in the art could, based on actual requirements, selectively set the method of determining the application displayed in the first region, as long as principles of the present disclosure can be realized.

In some embodiments, in step S102, displaying the second portion of content may further comprise: determining a display effect of the second portion of content based on a predetermined matching relationship. The display effect may comprise one or more of the following: color (for example, background color), style (for example, a hypostatization style or a flattening style), layout (for example, a landscape layout or a portrait layout), border decoration (for example, a pattern or a figure), and the like. Although several display effects are illustrated above, the present disclosure is not limited thereto. Those skilled in the art could, based on actual requirements, selectively set the display effect, as long as principles of the present disclosure can be realized.

Still taking the situation shown in FIG. 2 as an example, it is assumed that a predetermined matching relationship exists between WeChat and the address book, and the predetermined matching relationship indicates that the display layout of the address book is a landscape tiling layout. Therefore, in displaying the second portion of content, the interface of the address book is used as the second portion of content and the display layout of the address book is determined as the landscape tiling layout based on the predetermined matching relationship.

Although determination of the display effect of the second portion of content based on the predetermined matching relationship is exemplarily illustrated above, the present disclosure is not limited thereto. Those skilled in the art could also employ any appropriate manners to determine the display effect of the second portion of content, as long as principles of the present disclosure can be realized.

Moreover, although the processing for determining the display effect of the second portion of content is illustrated above, the display method 100 according to the present disclosure may also determine the display effect of the first portion of content based on the predetermined matching relationship. Reference can be made to the above descriptions for both the predetermined matching relationship and the display effect of the first portion of content, therefore repeated descriptions will be omitted herein.

It is noted that, in some embodiments, the second portion of content can be not only built-in content of the smartphone placed during manufacturing, such as the above-described address book, but also a clock, calendar and the like. Therefore, advantages of the display method 100 of the present disclosure include the following: the first portion of content can be associated with the second portion of content based on the above-described predetermined matching relationship, and the association may include not only an association of displayed content between the first portion of content and the second portion of content, but also an association of display effect between the first portion of content and the second portion of content, and presence of such associations allows the second portion of content to be displayed and selected by a user like an application, thereby further improving user's usage experience.

Although a manner of association between a first application and the second portion of content is exemplarily illustrated above, the present disclosure is not limited thereto. Those skilled in the art could, based on actual requirements, selectively set the association manner of the first application and the second portion of content, as long as principles of the present disclosure can be realized.

In some embodiments, step S101 may also comprise: obtaining an interface of the first application and using the interface of the first application as the first portion of content, and obtaining the second portion of content independent of the first application.

A description will be made in conjunction with FIG. 2 hereinafter. As shown in FIG. 2, the first application is WeChat and the interface of the first application is an interface of WeChat, and thus the interface of WeChat is used as the first portion of content. The second portion of content is an interface of an address book, wherein the interface of the address book is obtained independently of WeChat; that is to say, content in the interface of the address book is not determined according to WeChat. Specifically, as shown in FIG. 2, the interface of WeChat displays several WeChat friends, for example, “Lenali”, “Xiao Xiaoling” and “Da Fa” and so on, while in the interface of the address book, contact addresses of a smartphone contact list may be correspondingly displayed, the contact list may be arranged by way of the number of strokes of the surname, Pinyin and the like. The contact list is not associated with a WeChat friend list displayed on the interface of WeChat, and thus, contact addresses of the several contacts, for example, “Lenali”, “Xiao Xiaoling” and “Da Fa” and so on, are not displayed on the interface of the address book, at least the contact addresses of these contacts are not displayed simultaneously. Additionally, in the situation shown in FIG. 2, when the WeChat friend list displayed in the interface of WeChat is changed, the contacts displayed in the interface of the address book are not changed therewith. The advantage of doing so is that the content displayed in the interface of the address book can be kept in a relatively stable state, for example, only recently dialed contacts are displayed, enabling the user to select the recently dialed contact directly from the interface of the address book and to make a phone call, thereby improving user experience.

Additionally, the second portion of content may also be a system-level application portal related to the smartphone. For example, the second portion of content may be a clock icon and a short message icon and the like of the smartphone. An advantage of configuring the second portion of content to be the system-level application portal is enabling the user to quickly initiate a system-level application of the smartphone through the second portion of content, thereby increasing a display efficiency and improving user usage experience.

Moreover, although the determining of the display effect of the second portion of content and/or the determining of the display effect of the first portion of content based on the predetermined matching relationship are described above, the present disclosure is not limited thereto. The first portion of displayed content and/or the second portion of displayed content can also be determined based on the predetermined matching relationship. For example, as described in the above examples, the contact list that is displayed on the interface of the address book may be determined according to the friend list that is displayed on the interface of WeChat.

The smartphone according to the present disclosure can divide a screen of a non-standard display ratio into two regions, wherein one region displays the first portion of content in a standard display ratio, while the other region displays the second portion of content, so that conditions such as display distortion and twisting and the like of the screen of a non-standard display ratio can be avoided and user's usage experience can also be improved.

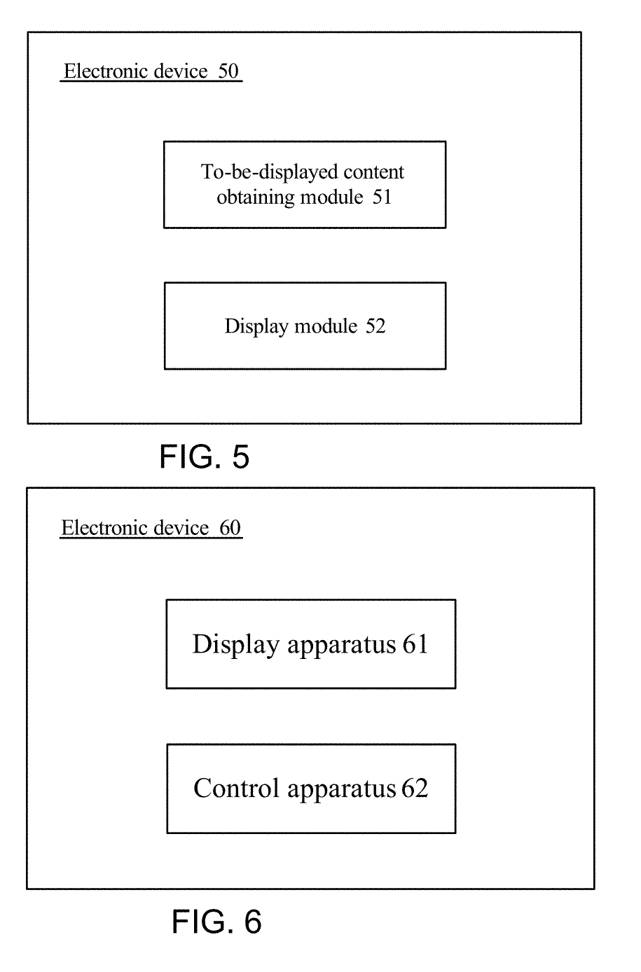

An electronic device 50 according to an embodiment of the present disclosure will be described below with reference to FIG. 5. The display method 100 described above with reference to FIG. 1 to FIG. 4 may be applied to the electronic device 50. Herein, the electronic device 50 will be illustrated in conjunction with FIG. 1 to FIG. 4.

The electronic device 50 according to the embodiment may be an electronic device, including desktop computers, laptop computers, tablet computers, smartphones, personal digital assistants, smart wearable devices and the like. Hereinafter, for ease of description, a smartphone will be taken as an example of such electronic devices for description. Thus, “smartphone 50” described hereinafter should be understood as an illustrative expression of an electronic device 50 of the present disclosure, and should not be construed as a limitation to the electronic device 50 of the present disclosure. As is well known to those skilled in the art, the smartphone comprises components such as a display unit, a control unit, and the like.

As shown in FIG. 5, the smartphone 50 comprises a to-be-displayed content obtaining module 51 and a display module 52. It should be noted that for simplification of description, FIG. 5 only illustrates components in the smartphone 50 that are related to principles of the present disclosure, and other components, for example, a control module and a storage module and the like, that are well known to those skilled in the art are omitted. Those skilled in the art could, based on principles of the present disclosure, selectively set other components that are omitted in FIG. 5. The to-be-displayed content obtaining module 51 and the display module 52 will be explained below.

The to-be-displayed content obtaining module 51 is configured to obtain to-be-displayed content, wherein the to-be-displayed content comprises a first portion of content and a second portion of content.

The to-be-displayed content is content to be displayed on a display unit of the smartphone. The to-be-displayed content may come from the smartphone itself, such as video and audio files in the smartphone's memory played through a built-in video player. The to-be-displayed content may also come from other devices external to the smartphone, such on-line videos viewed by using a browser through a Wi-Fi connection.

The to-be-displayed content comprises a first portion of content and a second portion of content. The first portion of content and the second portion of content may come from the same source. For example, both may come from the smartphone itself. The first portion of content can comprise a player interface of a video player that is pre-installed in the smartphone, and the second portion of content may be a display interface of an instant messaging tool (such as WeChat) or a third-party application and the like that is pre-installed in the smartphone. The first portion of content and the second portion of content may come from different sources. For example, the first portion of content may be displayed content of the instant messaging tool that is pre-installed in the smartphone, while the second portion of content may be a player interface of online videos viewed through a browser by the smartphone.

Although the first portion of content and the second portion of content are exemplarily illustrated above, the present disclosure is not limited thereto. Those skilled in the art could, based on actual requirements, selectively set the first portion of content and the second portion of content, as long as principles of the present disclosure can be realized. The first portion of content and the second portion of content will be further illustrated in conjunction with specific examples later.

The display module 52 is configured to display the first portion of content in a first region of a display unit, and to display the second portion of content in a second region of the display unit, wherein, the first region and the second region do not overlap with each other, a display ratio of the first region is the same as that of the first portion of content, a display ratio of the second region is the same as that of the second portion of content, and the display ratio of the first portion of content is different from that of the display unit

In some embodiments, the display ratio of the first portion of content according to the present disclosure is predetermined. The predetermined display ratio can be preset by a developer of the first portion of content so as to be fixed in display attributes of the first portion of content, and can also be an optimal display ratio determined by the first portion of content based on hardware configurations of the smartphone. Therefore, although the dimension of the first portion of content is scalable, the first portion of content cannot match the entire display unit of the smartphone by scaling since the display ratio of the first portion of content is different from that of the display unit.

The smartphone of the embodiment will be described below in detail in conjunction with examples of FIG. 2 to FIG. 4. A description is first made in conjunction with FIG. 2. As shown in FIG. 2, a display ratio of a display unit 21 is 16:16. That is, a display unit of the smartphone is square. Defining the display ratio of the display unit 21 as 16:16 herein is only specified for ease of comparison and illustration of the display ratios of the display unit and of the individual regions. For example, in practice, display ratio of a non-standard ratio display unit may also be represented in the form of 1:1 and the like.

Assuming a situation as shown in FIG. 2 in which a standard display ratio of the display unit is defined as 16:9, and assuming that a display ratio of an interface of a particular application that is displayed on the display unit 21 of the smartphone is the same as the defined standard display ratio, (that is, the display ratio of the interface of the particular application is also 16:9), it can be known that the display ratio of the display unit 21 of the smartphone is not a standard display ratio. Therefore, when the particular application is run on the smartphone, the display ratio (16:9) of the interface of the particular application is not matched with the display ratio (16:16) of the display unit 21, which leads to the occurrence of twisting, scaling and even distortion conditions in the interface of the particular application.

In the situation as shown in FIG. 2, WeChat is taken as an example of the above-described particular application. The first portion of content obtained by the to-be-displayed content obtaining module 51 is a display interface of WeChat application, and the obtained second portion of content is a display interface of an address book. In order to enable the to-be-displayed content obtaining module 51 to obtain the display interface of WeChat and the display interface of the address book, a user may initiate the WeChat application and open the address book.

As shown in FIG. 2, the display module 52 displays the display interface of WeChat in a first region 211 of a display unit 21 and displays the display interface of an address book in a second region 212 of the display unit 21.

The first region 211 and the second region 212 do not overlap with each other. As shown in FIG. 2, the first region 211 is located above the second region 212. A display ratio of the first region 211 is the same as that of the first portion of content (that is, the display interface of WeChat) (both are 16:9); a display ratio of the second region 212 is the same as that of the second portion of content (that is, the display interface of the address book), (both are 16:7). The display ratio (16:9) of the first portion of content is different from the display ratio (16:16) of the display unit 21.

An advantage of the situation shown in FIG. 2 lies in that, regarding a screen of a non-standard display ratio, the displaying of the first portion of content in a standard display ratio can be ensured so as to avoid the occurrence of conditions such as twisting, deformation and distortion and the like in the particular application during display, and the area of the first region 211 can also be reduced appropriately. As described above, the first region 211 displays an interface of a particular application such as a video player and WeChat and the like, thus appropriately reducing the area of the first region is advantageous for saving computing resources of the smartphone, thereby saving power. Further, in the situation shown in FIG. 2, the second region 212 is disposed external to the first region 211. Therefore, the second portion of content, such as the address book, can be displayed in the second region 212, such that more types of content can be displayed on the display unit 21 for users, thereby facilitating prompting the user and improving user experience of a non-standard ratio screen.

Moreover, advantages of the situation shown in FIG. 2 further lie in that, in some instances, in developing an application such as WeChat shown in FIG. 2, a customized development of display of applications is not required. That is to say, the display ratio of the application is not required to be customized to thereby accommodate the non-standard ratio screen. Instead, the applications only need to be displayed in a standard display ratio or in a general display ratio. In other instances, it may not be necessary for a manufacturer of a mobile electronic device such as a smartphone to limit a display screen of the mobile electronic device to a standard ratio screen. Therefore, the display method of the present disclosure is more advantageous for use of an application having a general display ratio on a device having a screen of a special display ratio.

Although in FIG. 2, a positional relationship between the first region 211 and the second region 212 is shown (wherein the first region 211 and the second region 212 are arranged in a sequential manner from an upper end to a lower end of the display unit 21), the present disclosure is not limited thereto. The display module 52 may be further configured to arrange the second region 212 and the first region 211 in a sequential manner from the upper end to the lower end of the display unit 21. In addition, the display module 52 can be further configured to dispose the first region 211 in a middle region of the display unit 21, so that the first region 211 is divided into two sub-regions (a first sub-region and a second sub-region) and the two sub-regions are disposed in an upper portion and a lower portion of the first region 211, respectively. Hence, in such a situation, the first sub-region, the first region 211 and the second sub-region are arranged in a sequential manner from the upper end to the lower end of the display unit 21.

Although in the example described above with reference to FIG. 2, the standard display ratio is defined as 16:9 and a display ratio of an interface of a particular application such as WeChat is set to be the same as the standard display ratio, as is well known to those skilled in the art, there may be a variety of standard display ratios (for example, the above-described ratio of 4:3). Still taking the above situation shown in FIG. 2 as an example, if the standard display ratio and the display ratio of the display interface of WeChat are set to 4:3 (i.e., 16:12), then in step S102, the display ratio of the first region 211 is the same as that of the display interface of WeChat, (16:12), and the display ratio of the second region 212 is the same as that of the display interface of the address book, (16:4).

A description is made below in conjunction with FIG. 3. As shown in FIG. 3, a display ratio of a display unit 31 is 16:5. That is, a display unit 31 of a smartphone is elongated, strip-like and rectangular. Defining the display ratio of the display unit 31 as 16:5 is only for ease of comparison and illustration of the display ratios of the display unit and of the individual regions. For example, in some embodiments, the display ratio of the display unit as a non-standard ratio may also be represented by any other appropriate ratio formulas.

Assuming a situation as shown in FIG. 3 in which a standard display ratio of the display unit is defined as 16:10, and assuming that the display ratio of an interface of a particular application that is displayed on the display unit 31 of the smartphone 30 is the same as the defined standard display ratio (that is, the display ratio of the interface of the particular application is also 16:10), it can be known that the display ratio of the display unit 31 of the smartphone 30 is not a standard display ratio. Therefore, when the particular application is run on the smartphone 30, the display ratio (16:10) of the interface of the particular application is not matched with the display ratio (16:5) of the display unit 31, which leads to the occurrence of twisting, scaling and even distortion conditions in the interface of the particular application.

In the situation as shown in FIG. 3, WeChat is still taken as an example of the above-described particular application. The first portion of content obtained by the to-be-displayed content obtaining module 51 is a display interface of WeChat application, and the obtained second portion of content is a display interface of an address book. In order to enable the to-be-displayed content obtaining module 51 to obtain the display interface of WeChat and the display interface of the address book, a user may initiate the WeChat application and open the address book.

As shown in FIG. 3, the display module 52 displays the display interface of WeChat in a first region 311 of a display unit 31 and displays the display interface of the address book in a second region 312 of the display unit 31.

The first region 311 and the second region 312 do not overlap with each other. As shown in FIG. 3, the first region 311 is located at a left side of the second region 312. A display ratio of the first region 311 is the same as that of the first portion of content (that is, the display interface of WeChat), both are 16:10 (i.e., 8:5); a display ratio of the second region 312 is the same as that of the second portion of content (that is, the display interface of the address book), both are 16:10 (i.e., 8:5), and the display ratio (16:10) of the first portion of content is different from the display ratio (16:5) of the display unit 31.

An advantage of the situation shown in FIG. 3 lies in that, in regard to a screen of a non-standard display ratio, the displaying of the first portion of content in a standard display ratio can be ensured so as to avoid the occurrence of conditions such as twisting, deformation and distortion and the like in the particular application during display, and the area of the first region 311 can also be reduced appropriately. As described above, the first region 311 displays an interface of a particular application such as a video player and WeChat and the like, thus appropriately reducing the area of the first region is advantageous for saving computing resources of the smartphone, thereby saving power. Further, in the situation shown in FIG. 3, a second region 312 is disposed external to the first region 311. Therefore, the second portion of content, such as the address book, can be displayed in the second region 312, such that more types of content can be displayed on the display unit 31 for users, thereby facilitating prompting the user and improving user experience of a screen of a non-standard display ratio.

Although in FIG. 3, a positional relationship between the first region 311 and the second region 312 is shown as the first region 311 and the second region 312 being arranged in a sequential manner from a left end to a right end of the display unit 31, the present disclosure is not limited thereto, the display module 52 may further arrange the second region 312 and the first region 311 in a sequential manner from the left end to the right end of the display unit 31. In addition, the display module 52 may further dispose the first region 311 in a middle region of the display unit 31, so that the second region 312 is divided into two sub-regions (a third sub-region and a fourth sub-region) and the two sub-regions are disposed at a left side and a right side of the second region 312, respectively. Hence, in such a situation, the first sub-region, the second region 312 and the second sub-region are arranged in a sequential manner from the left end to the right end of the display unit 31.

A description is made below in conjunction with FIG. 4. A display unit 41 shown in FIG. 4 is similar to the display unit 21 shown above in conjunction with FIG. 2, a display ratio of the display unit 41 is 16:16. That is to say, a display unit of a smartphone 40 is square.

Assuming a situation as shown in FIG. 4 in which a standard display ratio of the display unit is defined as 4:3, and assuming that a display ratio of an interface of a particular application that is displayed on the display unit 41 of the smartphone 40 is the same as the defined standard display ratio, that is, the display ratio of the interface of the particular application is also 4:3. Thus, it can be known that the display ratio of the display unit 41 of the smartphone 40 is not a standard display ratio. Therefore, when the particular application is run on the smartphone 40, a problem that the display ratio (4:3) of the interface of the particular application is not matched with the display ratio (16:16) of the display unit 41 is easily caused, which leads to the occurrence of twisting, scaling and even distortion conditions in the interface of the particular application.

In the situation as shown in FIG. 4, WeChat is still taken as an example of the above-described particular application. The first portion of content obtained by the to-be-displayed content obtaining module 51 is a display interface of WeChat application, and the obtained second portion of content is a display interface of an address book.

As shown in FIG. 4, the display module 52 displays the display interface of WeChat in a first region 411 of a display unit 41 and displays the display interface of the address book in a second region 412 of the display unit 41.

The first region 411 and the second region 412 do not overlap with each other. A display ratio of the first region 411 is the same as that of the first portion of content (that is, the display interface of WeChat), both are 4:3; a display ratio of the second region 412 is the same as that of the second portion of content (that is, the display interface of the address book), and the display ratio (4:3) of the first portion of content is different from the display ratio (16:16) of the display unit 41. In the situations described above in conjunction with FIG. 2 and FIG. 3, the first region and the second region have only one common edge. In contrast, in the situation shown in FIG. 4, the first region 411 and the second region 412 have two common edges, that is, the first region 411 is located at an upper left side of the second region 412.

An advantage of the situation shown in FIG. 4 lies in that, the displaying of the first portion of content in a standard display ratio can be ensured, and the area of the first region can also be appropriately reduced. As described above, the first region 411 displays an interface of a particular application such as a video player and WeChat and the like, thus appropriately reducing the area of the first region is advantageous for saving computing resources of the smartphone, thereby saving power. Moreover, in the situation shown in FIG. 4, the area of the second region 412 is appropriately enlarged, thus, more second portion of content can be displayed, so that the second portion of content, such as the address book, can be better provided to the user.

In the situation shown in FIG. 4, the display module 52 can adjust the area of the first region 411 in response to the user's operation, so as to realize equalization of the amount of content information between the first portion of content and the second portion of content by adjusting the area of the first region 411. For example, assuming the situation shown in FIG. 4 where the user views videos through the first region 411 and browses webpages through the second region 412, if the user's demand for video content is not large (for example, only sounds are required to be played) while the user's demand for webpage content is relatively large, the user can approximately reduce the area of the first region 411 to enlarge the area of the second region 422. Thus, user experience in the situation shown in FIG. 4 can be further improved.

Although in FIG. 4, a positional relationship between the first region 411 and the second region 412 is shown as the first region 411 being located at an upper left side of the second region 412, the present disclosure is not limited thereto, the display module 52 may further dispose the second region 412 at an upper right side, a lower right side or a lower left side, etc., of the first region 411. In addition, the display module 52 may further dispose the first region 411 in a middle region of the display unit 21, so that the first region 211 is divided into a plurality of sub-regions, and the plurality of sub-regions are disposed around the first region 211, respectively.

Although in the several examples described above with reference to FIG. 2 to FIG. 4, a standard display ratio is exemplarily illustrated as 4:3, 16:9 and 16:10, the present disclosure is not limited thereto. Those skilled in the art could, based on actual requirements, selectively set a standard display ratio, as long as principles of the present disclosure can be realized.

Further, although in the several examples described above with reference to FIG. 2 to FIG. 4, the first regions 211, 311 and 411 are illustrated as a quadrangle, the present disclosure is not limited thereto. The first region may also be polygonal or an irregular shape.

Although in the above various examples, the display interface of WeChat is used as the first portion of content and the display interface of the address book is used as a second portion of content, the present disclosure is not limited thereto. Those skilled in the art could, based on actual requirements, selectively set the first portion of content and the second portion of content, as long as principles of the present disclosure can be realized.

In some embodiments, a smartphone 50 further comprises a first region determination module (not shown). The first region determination module is configured to obtain a display ratio of the display unit and obtain a display ratio of the first portion of content; and to determine the first region based on the display ratio of the display unit and the display ratio of the first portion of content.

The display ratio of the display unit can be set during factory manufacturing of the display unit, and is then read by the first region determination module in the display method 100. The display ratio of the display unit may also be obtained based on the user's operation. For example, the display ratio of the display unit of the smartphone may be manually input by the user, such that the display ratio is obtained by the first region determination module. Although different methods for obtaining the display ratio of the display unit are illustrated above, the present disclosure is not limited thereto. Those skilled in the art could, based on actual requirements, select the implementation for obtaining the display ratio of the display unit, as long as principles of the present disclosure can be realized.

A display ratio of the first portion of content may be a default display ratio that is preset in a smartphone. For example, an application such as a video player and an instant messaging tool may employ a general display ratio in the art as a default display ratio, and the general display ratio may be directly employed by the display method 52. In some embodiments, the display ratio of the first portion of content may also be set by the user. For example, the user may, based on his/her own operational habits and a display ratio of the smartphone, manually set the display ratio of the first portion of content. Although different methods for obtaining the display ratio of the first portion of content are illustrated above, the present disclosure is not limited thereto. Those skilled in the art could, based on actual requirements, select the implementation for obtaining the display ratio of the first portion of content, as long as principles of the present disclosure can be realized.

The processing for determining the first region based on the display ratio of the display unit and the display ratio of the first portion of content comprises the following: if the display ratio of the first portion of content is greater than that of the display unit, a long edge of the first region is set to coincide with a long edge of the display unit; and if the display ratio of the first portion of content is smaller than that of the display unit, a short edge is set to coincide with a short edge of the display unit.

The above-described processing for determining the first region is illustrated with reference to FIG. 2 and FIG. 3 below.

As shown in FIG. 2, the display ratio of the display unit 21 is 16:16 and the display ratio of the first portion of content is 16:9, and thus it can be determined that the display ratio of the first portion of content is greater than the display ratio of the display unit 21. In the situation shown in FIG. 2, in determining the first region 211, a long edge of the first region 211 is configured to be coincident with any one of the edges of the display unit 21. After determining the long edge of the first region 211, the length of a short edge of the first region 211 can be determined based on the display ratio of the first portion of content. The first region 211 is thus determined.

As shown in FIG. 3, the display ratio of the display unit 31 is 16:5 and the display ratio of the first portion of content is 16:10. Thus it can be determined that the display ratio of the first portion of content is smaller than the display ratio of the display unit 31. In the situation shown in FIG. 3, in determining the first region 311, a short edge of the first region 311 is configured to be coincident with a short edge of the display unit 31. After determining the short edge of the first region 311, the length of the long edge of the first region 311 can be determined based on the display ratio of the first portion of content. The first region 311 is thus determined.

Although the method of determining the first region through the first region determination module is exemplarily illustrated with reference to FIG. 2 and FIG. 3 above, the present disclosure is not limited thereto. Those skilled in the art could, based on actual requirements, employ any appropriate methods to determine the first region, as long as principles of the present disclosure can be realized.

In some embodiments, the processing performed by the display module 52 for displaying the first portion of content in the first region of the display unit comprises the following: processing the first portion of content in a first processing manner if the display ratio of the first portion of content is greater than that of the display unit; and processing the first portion of content in a second processing manner if the display ratio of the first portion of content is smaller than that of the display unit, wherein the first processing manner is different from the second processing manner.

The above-described processing of the first portion of content by employing the first processing manner or the second processing manner is similar to the processing for determining the first region as described with reference to FIG. 2 and FIG. 3 above. Herein, the first processing manner and the second processing manner will be illustrated in conjunction with FIG. 2 and FIG. 3.

As shown in FIG. 2, the display ratio of the display unit 21 is 16:16 and the display ratio of the interface of WeChat is 16:9, and thus it can be determined that the display ratio of the interface of WeChat is greater than the display ratio of the display unit 21. In this situation, the first processing manner may configure a long edge of the interface of WeChat to be coincident with any one of edges of the display unit 21, and to determine the length of a short edge of the interface of WeChat based on the display ratio of the interface of WeChat and the long edge of the interface of WeChat.

Although FIG. 2 exemplarily illustrates the first processing manner, the present disclosure is not limited thereto. For instance, the first processing method may also adjust the dimension of the first portion of content in the display unit 21 based on the long edge of the first portion of content and the display ratio thereof.

As shown in FIG. 3, the display ratio of the display unit 31 is 16:5 and the display ratio of the interface of WeChat is 16:10, and thus it can be determined that the display ratio of the interface of WeChat is smaller than the display ratio of the display unit 31. In this situation, the second processing manner may configure the short edge of the interface of WeChat to be coincident with the short edge of the display unit 31, and determine the length of the long edge of the interface of WeChat based on the display ratio of the interface of WeChat and the short edge of the interface of WeChat.

Although FIG. 3 exemplarily illustrates the second processing manner, the present disclosure is not limited thereto. For instance, the second processing method may also adjust the dimension of the first portion of content in the display unit 21 based on the short edge of the first portion of content and the display ratio thereof.

It should be noted that the above-described first region determination module can be an independent module that independently acquires the display ratio of the display unit and acquires the display ratio of the first portion of content, and can also be incorporated into the display module 52 to thereby become a submodule of the display module 52.

In some embodiments, the smartphone 50 may further comprise a determination module for a second portion of content (not shown). The determination module for the second portion of content is configured to obtain an interface of a first application and to use the interface of the first application as the first portion of content, and to determine the second portion of content based on the first application.

A description will be made in conjunction with FIG. 2 below. As shown in FIG. 2, the first application is WeChat and an interface of the first application is an interface of WeChat, and thus the interface of WeChat is used as the first portion of content. The second portion of content is an interface of an address book, wherein the interface of the address book is determined according to WeChat. That is, content in the interface of the address book is determined according to WeChat. Specifically, as shown in FIG. 2, the interface of WeChat displays several WeChat friends, for example, “Lenali”, “Xiao Xiaoling” and “Da Fa” and so on. Accordingly, contact addresses of the several contacts of “Lenali”, “Xiao Xiaoling” and “Da Fa”, and so on are correspondingly displayed in the interface of the address book. Additionally, in the situation shown in FIG. 2, when a WeChat friend list displayed in the interface of WeChat is changed, the contacts displayed in the interface of the address book are also changed, and the friends in the WeChat friend list correspond to the contacts in the interface of the address book. The advantage of doing so is that WeChat and the address book can be associated with each other to better prompt a user. For example, if a user wants to make a phone call after seeing a message of a certain WeChat friend, the user may directly select the contact from the interface of the address book and make a phone call, thereby improving user experience.

In some embodiments, in step S102, displaying the second portion of content may further comprise: determining an application displayed in the first region, selecting a corresponding second portion of content based on a predetermined matching relationship, and displaying the second portion of content.

Taking the situation shown in FIG. 2 as an example, it is assumed that a predetermined matching relationship exists between WeChat and the address book. In step S102, after it is determined that the application displayed in the first region is WeChat, the interface of the address book is displayed in the second region based on the predetermined matching relationship.

The predetermined matching relationship can be preset in a smartphone during factory manufacturing of the smartphone, or can also be set by a user based on his/her own daily usage habits. Those skilled in the art could also set the predetermined matching relationship based on any other appropriate manners, as long as principles of the present disclosure can be realized.

In some embodiments, the step of determining an application displayed in the first region may comprise detecting an application that is currently activated or detecting an application that is switched to a display state.

Still taking the situation shown in FIG. 2 as an example, the smartphone may detect the application that is currently activated, or may detect the application that is switched to the display state. For example, the smartphone may detect an application icon displayed on a display unit of the smartphone based on a user, and if it is detected that the user clicks a certain application icon (for example, a WeChat icon), then it is detected that the currently activated application is WeChat. As another example, the smartphone may detect the user's display switching operation (for example, a click operation on a virtual switch key on the display unit by the user). If the user's display switching operation is detected, then an object of the display switching operation is detected as the application that is switched to the display state. Although several methods for determining the application that is displayed in the first region are exemplarily illustrated above, the present disclosure is not limited thereto. Those skilled in the art could, based on actual requirements, selectively set a manner of determining an application that is displayed in the first region, as long as principles of the present disclosure can be realized.

In some embodiments, in step S102, displaying the second portion of content may further comprise the following: determining a display effect of the second portion of content based on a predetermined matching relationship. The display effect comprises one or more of color, style, layout and border decoration and the like. Although several display effects are illustrated above, the present disclosure is not limited thereto. Those skilled in the art could, based on actual requirements, selectively set the display effect, as long as principles of the present disclosure can be realized.

Still taking the situation shown in FIG. 2 as an example, it is assumed that a predetermined matching relationship exists between WeChat and the address book, and the predetermined matching relationship indicates that a display layout of the address book is a landscape tiling layout. Therefore, in displaying the second portion of content, an interface of the address book is used as the second portion of content and a display layout of the address book is determined as the landscape tiling layout based on the predetermined matching relationship.

Although determination of the display effect of the second portion of content based on the predetermined matching relationship is exemplarily illustrated above, the present disclosure is not limited thereto. Those skilled in the art could also employ any appropriate method to determine the display effect of the second portion of content, as long as principles of the present disclosure can be realized.

Moreover, although the processing for determining the display effect of the second portion of content is illustrated above, the display method 100 according to the present disclosure may also determine the display effect of the first portion of content based on the predetermined matching relationship. Reference can be made to the above description for both the predetermined matching relationship and the display effect of the first portion of content, therefore repeated descriptions will be omitted herein.

It is noted that, in some embodiments, the second portion of content can be built-in content of the smartphone during factory manufacturing, such as the above-described address book, and, in other embodiments, can also be a clock, calendar and the like. Therefore, advantages of the display method 100 of the present disclosure lie in that: the first portion of content can be associated with the second portion of content based on the above-described predetermined matching relationship, and the association may include an association of displayed content between the first portion of content and the second portion of content, which may also include an association of display effects between the first portion of content and the second portion of content, presence of such associations allows the second portion of content to be displayed and selected by a user like an application, thereby further improving user's usage experience.

Although an association manner between a first application and the second portion of content is exemplarily illustrated above, the present disclosure is not limited thereto. Those skilled in the art can also, based on actual requirements, selectively set the association manner between the first application and the second portion of content, as long as principles of the present disclosure can be realized.

In some embodiments, the smartphone 50 may further comprise a determination module for the second portion of content (not shown). The determination module for the second portion of content is configured to obtain an interface of a first application and use the interface of the first application as the first portion of content, and to obtain the second portion of content independent of the first application.

A description will be made in conjunction with FIG. 2 below. As shown in FIG. 2, the first application is WeChat and an interface of the first application is an interface of WeChat, and thus the interface of WeChat is used as the first portion of content. The second portion of content is an interface of an address book, wherein an interface of the address book is obtained independently of WeChat, that is, content in the interface of the address book is not determined according to WeChat. Specifically, as shown in FIG. 2, the interface of WeChat displays several WeChat friends, for example, “Lenali”, “Xiao Xiaoling” and “Da Fa” and so on, while in the interface of the address book, contact addresses of a smartphone contact list may be correspondingly displayed, the contact list may be arranged by way of the number of strokes of the surname, Pinyin and the like. The contact list is not associated with a WeChat friend list that is displayed on the interface of WeChat, and thus, contact addresses of the several contacts, for example, “Lenali”, “Xiao Xiaoling” and “Da Fa” and so on, are not displayed on the interface of the address book, at least the contact addresses of these contacts are not displayed simultaneously. Additionally, in the situation shown in FIG. 2 when the WeChat friend list displayed in the interface of WeChat is changed, the contacts displayed in the interface of the address book are not changed therewith. The advantage of doing so is that, the content displayed in the interface of the address book can be kept in a relatively stable state. For example, only recently dialed contacts are displayed, enabling the user to directly select the recently dialed contact from the interface of the address book and to make a phone call, thereby improving user experience.

Additionally, the second portion of content may also be a system-level application portal related to the smartphone. For example, the second portion of content may be a clock icon and a short message icon and the like of the smartphone. An advantage of configuring the second portion of content as the system-level application portal is enabling the user to quickly initiate a system-level application of the smartphone through the second portion of content, thereby increasing a display efficiency and improving user usage experience.

Moreover, although the determining of the display effect of the second portion of content and/or the determining of the display effect of the first portion of content based on the predetermined matching relationship are described above, the present disclosure is not limited thereto. The first portion of displayed content and/or the second portion of displayed content can also be determined based on the predetermined matching relationship. For example, as described in the above examples, the contact list that is displayed on the interface of the address book is determined based on the friend list that is displayed on the interface of WeChat.

The smartphone according to the present disclosure can divide a screen of a non-standard display ratio into two regions, wherein one region displays the first portion of content in a standard display ratio, while the other region displays the second portion of content, so that conditions such as display distortion and twisting and the like of the screen of a non-standard display ratio can be avoided and the user's experience can be improved.

An electronic device 60 according to an embodiment of the present disclosure will be described with reference to FIG. 6 below. The display method 100 described above with reference to FIG. 1 to FIG. 4 may be applied to the electronic device 60. Herein, the electronic device 60 will be illustrated in conjunction with FIG. 1 to FIG. 4.

The electronic device 60 according to the embodiment may be an electronic device such as a desktop, laptop computer, tablet computer, smartphone, personal digital assistant, smart wearable device and the like. Hereinafter, for ease of description, a smartphone will be taken as an example of such electronic devices for description. Thus, “smartphone 60” described hereinafter should be understood as an illustrative expression of the electronic device 60 of the present disclosure, and should not be construed as a limitation to the electronic device 60 of the present disclosure.

As shown in FIG. 6, the smart phone 60 comprises a display apparatus 61 and a control apparatus 62. It should be noted that, for simplification of description, FIG. 6 only illustrates components in the smartphone 60 that are related to principles of the present disclosure, and other components, for example, a control module and a storage module and the like that are known to those skilled in the art are omitted. Those skilled in the art could, based on principles of the present disclosure, selectively set other components that are omitted in FIG. 6. The display apparatus 61 and the control apparatus 62 will be described below.

The display apparatus has a first region and a second region. The display apparatus 61 may be, for example, a plasma display, an organic electroluminescent display and a liquid crystal display and the like. However, the present disclosure is not limited thereto. Those skilled in the art could select the type of the display apparatus based on actual requirements. Moreover, the display apparatus 61 may also be implemented through a touch display panel, such that the display apparatus 61 can respond to the user's touch operation.

The control apparatus 62 is configured to: obtain to-be-displayed content, wherein the to-be-displayed content comprises a first portion of content and a second portion of content; and display the first portion of content in a first region, and display the second portion of content in a second region, wherein the first region and the second region do not overlap with each other, a display ratio of the first region is the same as that of the first portion of content, a display ratio of the second region is the same as that of the second portion of content, and the display ratio of the first portion of content is different from that of the display apparatus.

The to-be-displayed content is content to be displayed on the display apparatus 61 of the smartphone 60. The to-be-displayed content may come from the smartphone 60 itself. For example, the smartphone 60 may play video and audio files from the smartphone's memory through a built-in video player. The to-be-displayed content may also come from other devices external to the smartphone 60 For example, the smartphone 60 may enable viewing of online videos by using a browser through a Wi-Fi connection.

The to-be-displayed content comprises a first portion of content and a second portion of content. The first portion of content and the second portion of content may come from the same source. For example, the first portion of content and the second portion of content may both come from the smartphone itself. For example, the first portion of content may be a player interface of a video player that is pre-installed in the smartphone 60, and the second portion of content may be a display interface of an instant messaging tool (such as WeChat) or a third-party application that is pre-installed in the smartphone 60.

The first portion of content and the second portion of content may come from different sources. For example, the first portion of content may be displayed content of an instant messaging tool that is pre-installed in the smartphone 60, while the second portion of content may be a player interface of an online video viewed through a browser by the smartphone 60.

The control apparatus 62 may be a processor such as a Central Processing Unit (CPU). The control apparatus 62 may also be implemented through an Embedded Controller (EC) or through any other appropriate processors or controllers that are known to those skilled in the art.

Although the first portion of content and the second portion of content are exemplarily illustrated above, the present disclosure is not limited thereto. Those skilled in the art could, based on actual requirements, selectively set the first portion of content and the second portion of content, as long as principles of the present disclosure can be realized. The first portion of content and the second portion of content will be further illustrated in conjunction with specific examples in the following parts.

It should be noted that a display ratio of the first portion of content according to the present disclosure may be predetermined. The predetermined display ratio can be preset by a developer of the first portion of content so as to be fixed in display attributes of the first portion of content, and can also be an optimal display ratio determined by the first portion of content based on hardware configurations of the smartphone. Therefore, although the dimension of the first portion of content is scalable, the first portion of content cannot match the entire display unit of the smartphone by scaling since the display ratio of the first portion of content is different from that of the display unit.

The smartphone 60 of the embodiment will be described hereinafter in detail in conjunction with FIG. 2 to FIG. 4. A description is first made in conjunction with FIG. 2. As shown in FIG. 2, a display ratio of a display apparatus 61 is 16:16. That is, a display apparatus of the smartphone 60 is square. Defining the display ratio of the display apparatus 61 as 16:16 here is only for ease of comparison and illustration of display ratios of the display apparatus and of respective regions herein. For example, in practice, the display ratio of the display apparatus as a non-standard ratio may also be represented in the form of 1:1 and the like.

Assuming a situation as shown in FIG. 2 in which a standard display ratio of the display apparatus is defined as 16:9, and assuming that a display ratio of an interface of a particular application that is displayed on the display apparatus 61 of the smartphone 60 is the same as the defined standard display ratio (that is, the display ratio of the interface of the particular application is also 16:9), it can be known that the display ratio of the display apparatus 61 of the smartphone 60 is not a standard display ratio. Therefore, when the particular application is run on the smartphone 60, the display ratio (16:9) of the interface of the particular application is not matched with the display ratio (16:16) of the display apparatus 61, which leads to the occurrence of twisting, scaling and even distortion conditions in the interface of the particular application.

In the situation as shown in FIG. 2, WeChat is taken as an example of the above-described particular application. The first portion of content obtained by the control apparatus 62 is a display interface of a WeChat application, and the obtained second portion of content is a display interface of an address book. To enable the control apparatus 62 to obtain the display interface of WeChat and the display interface of the address book, a user may operate to initiate the WeChat application and open the address book.

As shown in FIG. 2, the display interface of WeChat is displayed in the first region 211 of the display apparatus, and the display interface of the address book is displayed in the second region 212 of the display apparatus.

In some embodiments, the first region 211 and the second region 212 do not overlap with each other. As shown in FIG. 2, the first region 211 is located above the second region 212. A display ratio of the first region 211 is the same as that of the first portion of content (that is, the display interface of WeChat), (16:9); a display ratio of the second region 212 is the same as that of the second portion of content (that is, the display interface of the address book), (16:7), and the display ratio (16:9) of the first portion of content is different from the display ratio (16:16) of the display apparatus 21.

An advantage of the situation shown in FIG. 2 lies in that, in regard to a screen of a non-standard display ratio, the displaying of the first portion of content in a standard display ratio can be ensured so as to avoid the occurrence of conditions such as twisting, deformation and distortion and the like in the particular application during display, and the area of the first region 211 can also be reduced appropriately. As described above, the first region 211 displays an interface of a particular application such as a video player, WeChat and the like. Thus, appropriately reducing the area of the first region is advantageous for saving computing resources of the smartphone, thereby saving power. Further, in the situation shown in FIG. 2, the second region 212 is disposed external to the first region 211. Therefore, the second portion of content such as the address book can be displayed in the second region 212, such that more types of content can be displayed on the display apparatus for users, thereby facilitating prompting the user and improving user experience of a non-standard ratio screen.

Moreover, the advantage of the situation shown in FIG. 2 further lies in that, in some instances, in developing an application such as WeChat shown in FIG. 2, customized development of display of applications is not required. That is to say, the display ratio of the application is not required to be customized to thereby accommodate the non-standard ratio screen; instead, the application only needs to be displayed in a standard display ratio or in a general display ratio. In other instances, it may not be necessary for a manufacturer of a mobile electronic device such as a smartphone to limit a display screen of the mobile electronic device to a standard ratio screen. Therefore, the display method of the present disclosure is more advantageous for use of an application having a general display ratio on a device having a screen of a non-general display ratio.

Although in FIG. 2, a positional relationship between the first region 211 and the second region 212 is shown (wherein the first region 211 and the second region 212 are arranged in a sequential manner from an upper end to a lower end of the display apparatus 21), the present disclosure is not limited thereto. For example, the control apparatus 62 may be further configured to arrange the second region 212 and the first region 211 in a sequential manner from the upper end to the lower end of the display apparatus. In addition, the control apparatus 62 may be further configured to dispose the first region 211 in a middle region of the display apparatus, so that the first region 211 is divided into two sub-regions (a first sub-region and a second sub-region) and the two sub-regions are disposed at an upper portion and a lower portion of the first region 211, respectively. Hence, in such a situation, the first sub-region, the first region 211 and the second sub-region are arranged in a sequential manner from the upper end to the lower end of the display apparatus.

Although in the example described above with reference to FIG. 2, a standard display ratio is defined as 16:9 and a display ratio of an interface of a particular application such as WeChat is set to be the same as the standard display ratio, it is known to those skilled in the art that a variety of standard display ratios may exist, such as the above-described ratio of 4:3. Further taking the above situation shown in FIG. 2 as an example, if the standard display ratio and the display ratio of the display interface of WeChat are set to 4:3 (i.e., 16:12), then the display ratio of the first region 211 is the same as that of the display interface of WeChat, (16:12), and the display ratio of the second region 212 is the same as that of the display interface of the address book, (16:4).

A description is made below in conjunction with FIG. 3. As shown in FIG. 3, the display ratio of the display apparatus is 16:5. That is, a display apparatus of a smartphone in this example is elongated, strip-like and rectangular. Defining the display ratio of the display apparatus as 16:5 herein is only for ease of comparison and illustration of display ratios of the display apparatus and of respective regions. For example, in practice the display ratio of the display apparatus as a non-standard ratio may also be represented by any other appropriate ratio formulas.

Assuming a situation as shown in FIG. 3 in which a standard display ratio of the display apparatus is defined as 16:10, and assuming that the display ratio of an interface of a particular application that is displayed on the display apparatus of the smartphone 60 is the same as the defined standard display ratio (that is, the display ratio of the interface of the particular application is also 16:10), it can be known that the display ratio of the display apparatus of the smartphone 60 is not a standard display ratio. Therefore, when the particular application is run on the smartphone 60, the display ratio (16:10) of the interface of the particular application is not matched with the display ratio (16:5) of the display apparatus, which leads to the occurrence of twisting, scaling and even distortion conditions in the interface of the particular application.

In the situation as shown in FIG. 3, WeChat is used as an example of the above-described particular application. The first portion of content obtained by the control apparatus 62 is a display interface of a WeChat application, and the obtained second portion of content is a display interface of an address book. To enable the control apparatus 62 to obtain the display interface of WeChat and the display interface of the address book, a user may open the WeChat application and the address book.

As shown in FIG. 3, the display interface of WeChat is displayed in the first region 311 of the display apparatus, and the display interface of the address book is displayed in the second region 312 of the display apparatus.

In some embodiments, the first region 311 and the second region 312 do not overlap with each other. As shown in FIG. 3, the first region 311 is located at a left side of the second region 312. A display ratio of the first region 311 is the same as that of the first portion of content (that is, the display interface of WeChat), (16:10, i.e., 8:5); a display ratio of the second region 312 is the same as that of the second portion of content (that is, the display interface of the address book), (16:10, i.e., 8:5), and the display ratio (16:10) of the first portion of content is different from the display ratio (16:5) of the display apparatus.

An advantage of the situation shown in FIG. 3 lies in that, in regard to a screen of a non-standard display ratio, the displaying of the first portion of content in a standard display ratio can be done so as to avoid the occurrence of conditions such as twisting, deformation and distortion and the like in the particular application during display, and the area of the first region 311 can also be reduced appropriately. As described above, the first region 311 displays an interface of a particular application such as a video player, WeChat and the like. Thus, appropriately reducing the area of the first region is advantageous for saving computing resources of the smartphone, thereby saving power. Further, in the situation shown in FIG. 3, the second region 312 is disposed external to the first region 311. Therefore, the second portion of content such as the address book can be displayed in the second region 312, such that more types of content can be displayed on the display apparatus for users, facilitating prompting the user and improving user experience of a screen of a non-standard display ratio.

Although a positional relationship between the first region 311 and the second region 312 is shown in FIG. 3 (wherein the first region 311 and the second region 312 being arranged in a sequential manner from a left end to a right end of the display apparatus), the present disclosure is not limited thereto, the second region 312 and the first region 311 can also be arranged in a sequential manner from the left end to the right end of the display apparatus. In addition, the first region 311 can also be disposed in a middle region of the display apparatus, so that the second region 312 is divided into two sub-regions (a third sub-region and a fourth sub-region) and the two sub-regions are disposed at a left side and a right side of the second region 312, respectively. Hence, in such a situation, the first sub-region, the second region 312 and the second sub-region are arranged in a sequential manner from a left end to a right end of the display apparatus.

A description is made below in conjunction with FIG. 4. The display apparatus shown in FIG. 4 is similar to the display apparatus shown above in conjunction with FIG. 2. The display ratio of the display apparatus is 16:16; that is to say, the display apparatus of the smartphone is square.

Assuming a situation as shown in FIG. 4 in which a standard display ratio of the display apparatus is defined as 4:3, and assuming that a display ratio of an interface of a particular application that is displayed on the display apparatus of the smartphone is the same as the defined standard display ratio (that is, the display ratio of the interface of the particular application is also 4:3), it can be known that the display ratio of the display apparatus of the smartphone is not a standard display ratio. Therefore, when the particular application is run on the smartphone, the display ratio (4:3) of the interface of the particular application is not matched with the display ratio (16:16) of the display apparatus, which leads to the occurrence of twisting, scaling and even distortion conditions in the interface of the particular application.

In the situation as shown in FIG. 4, WeChat is still taken as an example of the above-described particular application. The first portion of content obtained by the control apparatus 62 is a display interface of a WeChat application, and the obtained second portion of content is a display interface of an address book.

As shown in FIG. 4, the display interface of WeChat is displayed in the first region 411 of the display apparatus, and the display interface of the address book is displayed in the second region 412 of the display apparatus.

In some embodiments, the first region 411 and the second region 412 do not overlap with each other. A display ratio of the first region 411 is the same as that of the first portion of content (that is, the display interface of WeChat), (4:3); a display ratio of the second region 412 is the same as that of the second portion of content (that is, the display interface of the address book), and the display ratio (4:3) of the first portion of content is different from the display ratio (16:16) of the display apparatus. In the situations described above in conjunction with FIG. 2 and FIG. 3, the first region and the second region only have one common edge. In contrast, in the situation shown in FIG. 4, the first region 411 and the second region 412 have two common edges; that is, the first region 411 is located at an upper left side of the second region 412.

An advantage of the situation shown in FIG. 4 lies in that, the displaying of the first portion of content in a standard display ratio can be ensured, and the area of the first region can also be appropriately reduced. As described above, the first region 411 displays an interface of a particular application such as a video player and WeChat and the like. Thus, appropriately reducing the area of the first region is advantageous for saving computing resources of the smartphone, thereby saving power. Moreover, in the situation shown in FIG. 4, the area of the second region 412 is appropriately enlarged; thus, more second portion of content can be displayed, so that the second portion of content such as the address book can be better provided to the user.

In the situation shown in FIG. 4, the display apparatus can adjust the area of the first region 411 in response to a user's operation, so as to realize equalization of the amount of content information between the first portion of content and the second portion of content by adjusting the area of the first region 411. For example, in the situation shown in FIG. 4 where the user views videos through the first region 411 and browses webpages through the second region 412, if the user's demand for video content is slight (for example, only sounds are required to be played) while the user's demand for webpage content is great, the user can reduce the area of the first region 411 to enlarge the area of the second region 422. Thus, user experience in the situation shown in FIG. 4 can be further improved.

Although in FIG. 4, a positional relationship between the first region 411 and the second region 412 is shown (wherein the first region 411 being located at an upper left side of the second region 412), the present disclosure is not limited thereto. The display module may further dispose the second region 412 at an upper right side, a lower right side or a lower left side and the like of the first region 411. In addition, the display module may further dispose the first region 411 in a middle region of the display apparatus, so that the second region 211 is divided into a plurality of sub-regions, and the plurality of sub-regions are disposed around the first region 211, respectively.

Although in the several examples described above with reference to FIG. 2 to FIG. 4, the standard display ratio is exemplarily illustrated as 4:3, 16:9 and 16:10, the present disclosure is not limited thereto. Those skilled in the art could, based on actual requirements, selectively set a standard display ratio, as long as principles of the present disclosure can be realized.

Further, although in the several examples described above with reference to FIG. 2 to FIG. 4, the first regions 211, 311 and 411 are illustrated to be quadrangular, the present disclosure is not limited thereto. The first region may also be polygonal or of other irregular shapes.

Although in the above various examples, the display interface of WeChat is used as the first portion of content and the display interface of the address book is used as a second portion of content, the present disclosure is not limited thereto. Those skilled in the art could, based on actual requirements, selectively set the first portion of content and the second portion of content, as long as principles of the present disclosure can be realized.

In some embodiments, the control apparatus 62 may be further configured to obtain a display ratio of the display apparatus 61 and obtain a display ratio of the first portion of content, and determine the first region based on the display ratio of the display apparatus 61 and the display ratio of the first portion of content.

The display ratio of the display apparatus 61 can be set during factory manufacturing of the display apparatus, and then may be read by the first region determination module in the display method 100. The display ratio of the display apparatus 61 may also be obtained based on the user's operation. For example, the display ratio of the display apparatus 61 of the smartphone 60 may be manually input by the user, such that the control apparatus 62 obtains the display ratio. Although different methods for obtaining the display ratio of the display apparatus 61 are illustrated above, the present disclosure is not limited thereto. Those skilled in the art could, based on actual requirements, select the implementation for obtaining the display ratio of the display apparatus, as long as principles of the present disclosure can be realized.

In some embodiments, a display ratio of the first portion of content may be a default display ratio that is preset in the smartphone 60. For example, an application such as a video player and an instant messaging tool may employ a general display ratio known in the art as a default display ratio. Therefore, the general display ratio may be directly employed by the display apparatus 62. In some embodiments, the display ratio of the first portion of content may also be set by the user. For example, the user may manually set the display ratio of the first portion of content based on his/her own operational habits, the display ratio of the smartphone 60 and the like. Although different methods for obtaining the display ratio of the first portion of content are illustrated above, the present disclosure is not limited thereto. Those skilled in the art could, based on actual requirements, select the implementation for obtaining the display ratio of the first portion of content, as long as principles of the present disclosure can be realized.

The processing for determining the first region based on the display ratio of the display apparatus and the display ratio of the first portion of content comprises the following: if the display ratio of the first portion of content is greater than that of the display apparatus 61, a long edge of the first region is set to coincide with a long edge of the display apparatus 61; and if the display ratio of the first portion of content is smaller than that of the display apparatus 61, a short edge is set to coincide with a short edge of the display apparatus 61.

The above-described processing for determining the first region is illustrated below with reference to FIG. 2 and FIG. 3.

As shown in FIG. 2, the display ratio of the display apparatus is 16:16 and the display ratio of the first portion of content is 16:9; thus, it can be determined that the display ratio of the first portion of content is greater than the display ratio of the display apparatus. In the situation shown in FIG. 2, in determining the first region 211, the long edge of the first region 211 is configured to be coincident with any one of the edges of the display apparatus. After determining the long edge of the first region 211, the length of the short edge of the first region 211 can be determined based on the display ratio of the first portion of content. The first region 211 is thus determined.

As shown in FIG. 3, the display ratio of the display apparatus is 16:5 and the display ratio of the first portion of content is 16:10; thus, it can be determined that the display ratio of the first portion of content is smaller than the display ratio of the display apparatus. In the situation shown in FIG. 3, in determining the first region 311, the short edge of the first region 311 is configured to be coincident with the short edge of the display apparatus. After determining the short edge of the first region 311, the length of the long edge of the first region 311 can be determined based on the display ratio of the first portion of content. The first region 311 is thus determined.

Although the method of determining the first region by the control apparatus 62 is exemplarily illustrated with reference to FIG. 2 and FIG. 3 above, the present disclosure is not limited thereto. Those skilled in the art could, based on actual requirements, employ any appropriate methods to determine the first region, as long as principles of the present disclosure can be realized.

In some embodiments, processing for displaying the first portion of content in the first region of the display apparatus comprises the following: if the display ratio of the first portion of content is greater than that of the display apparatus, processing the first portion of content in a first processing manner; and if the display ratio of the first portion of content is smaller than that of the display apparatus, processing the first portion of content in a second processing manner, wherein the first processing manner is different from the second processing manner.

The above-described processing of the first portion of content by employing the first processing manner or the second processing manner is similar to the processing for determining the first region as described with reference to FIG. 2 and FIG. 3. Herein, the first processing manner and the second processing manner will be illustrated in conjunction with FIG. 2 and FIG. 3.

As shown in FIG. 2, the display ratio of the display apparatus is 16:16 and the display ratio of the interface of WeChat is 16:9, and thus it can be determined that the display ratio of the interface of WeChat is greater than the display ratio of the display apparatus. In this situation, the first processing manner may configure a long edge of the interface of WeChat to be coincident with any one of edges of the display apparatus, and determine the length of a short edge of the interface of WeChat based on the display ratio of the interface of WeChat and the long edge of the interface of WeChat.

Although FIG. 2 exemplarily illustrates the first processing manner, the present disclosure is not limited thereto. For instance, the first processing method may also adjust the dimension of the first portion of content in the display apparatus based on the long edge of the first portion of content and the display ratio thereof.

As shown in FIG. 3, the display ratio of the display apparatus is 16:5 and the display ratio of the interface of WeChat is 16:10; thus, it can be determined that the display ratio of the interface of WeChat is smaller than the display ratio of the display apparatus. In this situation, the second processing manner may configure the short edge of the interface of WeChat to be coincident with the short edge of the display apparatus, and determine the length of the long edge of the interface of WeChat based on the display ratio of the interface of WeChat and the short edge of the interface of WeChat.

Although FIG. 3 exemplarily illustrates the second processing manner, the present disclosure is not limited thereto. For instance, the second processing method may also adjust the dimension of the first portion of content in the display apparatus based on the short edge of the first portion of content and the display ratio thereof.

In some embodiments, the control apparatus 62 may be further configured to obtain an interface of a first application and use the interface of the first application as the first portion of content, and determine the second portion of content based on the first application.

A description will be given in conjunction with FIG. 2 below. As shown in FIG. 2, the first application is WeChat and an interface of the first application is an interface of WeChat, and thus the interface of WeChat is used as the first portion of content. The second portion of content is an interface of an address book, wherein the interface of the address book is determined according to WeChat. That is to say, content in the interface of the address book is determined according to WeChat. Specifically, as shown in FIG. 2, the interface of WeChat displays several WeChat friends “Lenali”, “Xiao Xiaoling” and “Da Fa” and so on. Accordingly, contact addresses of the several contacts of “Lenali”, “Xiao Xiaoling” and “Da Fa” and so on are correspondingly displayed in the interface of the address book. Additionally, in the situation shown in FIG. 2, when a WeChat friend list displayed in the interface of WeChat is changed, the contacts displayed in the interface of the address book are also changed so that the friends in the WeChat friend list correspond to the contacts in the interface of the address book. The advantage of doing so is that WeChat and the address book can be associated with each other to better prompt a user. If a user wants to make a phone call after seeing a message of a certain WeChat friend, the user may directly select the contact from the interface of the address book and make a phone call, thereby improving user experience.

In some embodiments, in step S102, displaying the second portion of content may further comprise: determining an application displayed in the first region, selecting the corresponding second portion of content based on a predetermined matching relationship, and displaying the second portion of content.

Taking the situation shown in FIG. 2 as an example, it is assumed that a predetermined matching relationship exists between WeChat and the address book. In step S102, after it is determined that the application displayed in the first region is WeChat, the interface of the address book is displayed in the second region based on the predetermined matching relationship.

The predetermined matching relationship may be preset in a smartphone during factory manufacturing of the smartphone, and may also be set by a user based on his/her own daily usage habits. Those skilled in the art could also, based on any other appropriate manners, set the predetermined matching relationship, as long as principles of the present disclosure can be realized.

In some embodiments, the step of determining the application displayed in the first region may comprise detecting an application that is currently activated or detecting an application that is switched to a display state.

Taking the situation shown in FIG. 2 as an example, the smartphone may detect an application that is currently activated, or may detect an application that is switched to the display state. For example, a smartphone may detect an application icon displayed on a display unit of the smartphone. If it is detected that the user clicks a certain application icon (for example, a WeChat icon), then it is determined that the currently activated application is WeChat. In another example, the smartphone may detect the user's display switching operation (for example, the user's click operation on a virtual switch key on the display unit). If the user's display switching operation is detected, then an object of the display switching operation is determined to be the application that is switched to the display state. Although several methods for determining the application displayed in the first region are exemplarily illustrated above, the present disclosure is not limited thereto. Those skilled in the art could, based on actual requirements, selectively set the method of determining an application displayed in the first region, as long as principles of the present disclosure can be realized.

In some embodiments, in step S102, displaying the second portion of content may further comprise the following: determining a display effect of the second portion of content based on a predetermined matching relationship. The display effect may comprise one or more of color, style, layout, border decoration and the like. Although several display effects are illustrated above, the present disclosure is not limited thereto. Those skilled in the art could, based on actual requirements, selectively set the display effect, as long as principles of the present disclosure can be realized.

Using the situation shown in FIG. 2 as an example, in some embodiments it is assumed that there is a predetermined matching relationship between WeChat and the address book, and the predetermined matching relationship indicates that a display layout of the address book is a landscape tiling layout. Therefore, in displaying the second portion of content, the interface of the address book is used as the second portion of content and the display layout of the address book is determined as the landscape tiling layout based on the predetermined matching relationship.

Although the determination of the display effect of the second portion of content based on the predetermined matching relationship is exemplarily illustrated above, the present disclosure is not limited thereto. Those skilled in the art could also employ any appropriate manners to determine the display effect of the second portion of content, as long as principles of the present disclosure can be realized.

Moreover, although the processing for determining the display effect of the second portion of content is illustrated above, the display method 100 according to the present disclosure may also determine the display effect of the first portion of content based on the predetermined matching relationship. Reference can be made to the above description for both the predetermined matching relationship and the display effect of the first portion of content, therefore repeated descriptions will be omitted herein.

It is noted that, in some embodiments, the second portion of content can be not only content built into the smartphone during factory manufacturing, such as the above-described address book, but may also comprise a clock, calendar and the like. Therefore, advantages of the display method 100 of the present disclosure lie in the following: the first portion of content can be associated with the second portion of content based on the above-described predetermined matching relationship, and the association may include an association of displayed content between the first portion of content and the second portion of content, and may also include an association of display effect between the first portion of content and the second portion of content. This enables the second portion of content to be displayed and selected by a user like an application, thereby further improving user's usage experience.

Although an association manner between a first application and the second portion of content is exemplarily illustrated above, the present disclosure is not limited thereto. Those skilled in the art could also, based on actual requirements, selectively set the manner of association between the first application and the second portion of content, as long as principles of the present disclosure can be realized.

In some embodiments, the control apparatus 62 may be further configured to obtain an interface of a first application and use the interface of the first application as the first portion of content, and obtain the second portion of content independent of the first application.

A description will be made below in conjunction with FIG. 2. As shown in FIG. 2, the first application is WeChat and an interface of the first application is an interface of WeChat, and thus the interface of WeChat is used as the first portion of content. The second portion of content is an interface of an address book, wherein the interface of the address book is obtained independently of WeChat. That is to say, content in the interface of the address book is not determined according to WeChat. Specifically, as shown in FIG. 2, the interface of WeChat displays several WeChat friends, for example, “Lenali”, “Xiao Xiaoling” and “Da Fa” and so on, while in the interface of the address book contact addresses of a smartphone contact list may be correspondingly displayed, the contact list may be arranged by various methods (e.g. by way of the number of strokes of the surname, Pinyin and the like). The contact list is not associated with a WeChat friend list that is displayed on the interface of WeChat, and thus, contact addresses of the several contacts such as “Lenali”, “Xiao Xiaoling” and “Da Fa” and so on are not displayed on the interface of the address book as a result of their appearance in the WeChat friend list (though they may coincidentally appear there). Additionally, in the situation shown in FIG. 2, when the WeChat friend list displayed in the interface of WeChat is changed, the contacts displayed in the interface of the address book are not changed therewith. The advantage of doing so is that the content displayed in the interface of the address book can be maintained in a relatively stable state. For example, only recently dialed contacts are displayed, which allows the user to select the recently dialed contact directly from the interface of the address book and make a phone call, thereby improving user experience.

In some embodiments, the smartphone 60 can divide a screen of a non-standard display ratio into two regions, wherein one region displays a first portion of content in a standard display ratio, while the other region displays a second portion of content, so that conditions such as display distortion and twisting and the like of the screen of a non-standard display ratio can be avoided and user's usage experience can also be improved.

In some embodiments, the smartphone 60 may have a first form and a second form wherein deformation amplitudes of the display apparatus 61 in the first form and in the second form are different.

For example, the display apparatus 61 may be implemented by a flexible display screen, wherein the flexible display screen may be flexed by means of bending and folding and the like. The first form may be a flattened state of the display apparatus 61, and the second form may be any flexed state other than the flattened state of the flexible display screen. In addition, in some embodiments, both the first form and the second form may be the flexed state, and the first form and the second form are different from each other. Since the display apparatus 61 implemented by the flexible display screen is well-known to those skilled in the art, further descriptions thereof will be omitted here. Those skilled in the art could, based on actual requirements, selectively set the first form and the second form. It should be noted that, generally, the display apparatus 61 will occupy a larger size of the smartphone 60 when viewed from a two-dimensional plane; thus, the form of the display apparatus 61 can be approximately considered as the form of the smartphone 60, and a deformation amplitude of the display apparatus 61 is approximately considered as a deformation amplitude of the smartphone 60.

When the electronic device 60 is implemented by a wearable electronic device such as a smart watch, electronic glasses or an electronic helmet, the electronic device 60 may also include a maintenance apparatus (not shown). The maintenance apparatus is used to, maintain a relative positional relationship between the electronic device and at least a part of the body of the user while the user wears the device. The maintenance apparatus may maintain relative positional relationships between the electronic device 60 and parts of the user such as head, face, eye, head and the like, to accurately obtain parameters such as actions, angles of actions and displacements of corresponding parts of the user.

In some embodiments, the maintenance apparatus at least comprises a first fixed state in which the maintenance apparatus can be used as an annular space or at least a part of an approximately annular space that satisfies a first predetermined condition, the annular space and the approximately annular space can surround a periphery of a columnar body that satisfies a second predetermined condition.

In the first fixed state, portions of the electronic device 60 other than the maintenance apparatus, together with the maintenance apparatus, form a closed-ring annular space, wherein the maintenance apparatus constitutes a part of the annular space together with portions other than the maintenance apparatus, respectively. In some embodiments, portions of the electronic device 60 other than the maintenance apparatus may also, together with the maintenance apparatus, form an approximate annular space having a small opening, wherein the maintenance apparatus constitutes a part of the annular space together with other portions than the maintenance apparatus, respectively. In some embodiments, the maintenance apparatus may be a watch band portion of the smart watch, and portions of the smart watch other than the maintenance apparatus comprise a watch face portion of the smart watch. The annular space or the approximately annular space formed by a watch band part and a watch face part can surround a user's wrist, and a diameter of the annular space and the approximately annular space is greater than a diameter of the user's wrist but smaller than a diameter of the user's fist.

In some embodiments, if the maintenance apparatus is in the first fixed state, the display apparatus is arc-shaped. As described above in conjunction with the smart watch (assuming that the first state is a state in which the smart watch is fixed around the user's wrist through the maintenance apparatus), in this first fixed state a display apparatus of the smart watch is arc-shaped. The display apparatus of the smart watch surrounds at least a part around the user's wrist in a certain arc.

In some embodiments, the display apparatus 61 may be a flexible display screen, and the electronic device 60 further includes a position determining apparatus (not shown). The position determining apparatus is configured, once it is detected that the flexible display screen is flexed, to acquire a position of a flexing line in the flexible display screen. The control apparatus 62 is further configured to divide the flexible display screen into the first region and the second region based on the position of the flexing line. In some embodiments, the control apparatus 62 is further configured to process the first portion of content in a first processing manner based on the first region. The first processing manner is described as above, and repeated descriptions are omitted here.

In some embodiments, the electronic device 60 may be an annular watch. In consideration of aesthetics of the annular watch, and in order to facilitate better displaying of the annular watch, a display ratio of the annular watch is generally relatively large, thereby causing the display ratio of the annular watch to be a non-standard display ratio or a non-common display ratio. Therefore, applying principles of the present disclosure to the annular watch will enable the annular watch to have the above-described advantages.

The position determining apparatus may be implemented by sensors such as a pressure sensor and an acceleration sensor. However, the present disclosure is not limited thereto; the position determining apparatus may also be implemented by any appropriate sensors that are known to those skilled in the art, as long as principles of the position determining apparatus of the present disclosure can be realized.

In some embodiments, the electronic device 60 may further comprise a detection means (not shown). The detection means is configured to detect whether the display apparatus 61 is obstructed and determine unobstructed regions of the display apparatus 61 when it is detected that the display apparatus is obstructed. Moreover, the control apparatus 62 is further configured to acquire display ratios of the unobstructed regions and compare the display ratios of the uncovered regions with the display ratio of the first portion of content, and then process the first portion of content based on the comparison result.

The detection means may be implemented by sensors such as a luminance sensor or a photosensitive sensor. However, the present disclosure is not limited thereto; the detection means may also be implemented by any appropriate sensors that are known to those skilled in the art, as long as principles of the position determining apparatus of the present disclosure can be realized. Reference can be made to the exemplary embodiments described above in conjunction with FIG. 2 and FIG. 3 for the processing performed by the control apparatus 62 for comparison between the display ratios of the uncovered regions and the display ratio of the first portion of content and the processing performed on the first portion of content based on the comparison result. For example, the unobstructed regions may be equivalent to the display unit 21 shown in FIG. 2 or the display unit 31 shown in FIG. 3, and the first portion of content may be equivalent to the interface of WeChat shown in FIG. 2 or FIG. 3.

It should be noted that the terms used herein are only for the purpose of describing particular embodiments, instead of limiting the present disclosure. Singular forms “a”, “an” and “the” as used herein are intended to include the plural forms as well, unless the context clearly indicates otherwise. Terms “comprises”, “comprising” or any other variations thereof are intended to cover a non-exclusive inclusion, such that a process, a method, an article, or a device that comprises a list of elements does not include only those elements but may include other elements not expressly listed or inherent to such process, method, article, or device. An element defined by the phrase “comprises . . . ” does not, without more constraints, preclude the existence of additional identical elements in the process, method, article, or device that comprises the element.

Those skilled in the art will appreciate that embodiments disclosed in the description may be implemented in the form of electronic hardware, computer software or a combination thereof. In order to illustrate interchangeability of hardware and software more clearly, components and steps of various examples have been generally described above in terms of functionalities. Whether these functionalities are implemented in the form of hardware or software depends upon particular applications and design constraints of the technical solutions. Those skilled in the art could implement the described functionalities by means of various methods for each particular application, but such implementation should not be interpreted as going beyond the scope of the present disclosure.

Those skilled in the art will appreciate that the above various embodiments are only for illustrating the technical solutions of the present disclosure instead of limiting the present disclosure. Although the present disclosure is illustrated in detail with reference to the foregoing embodiments, those skilled in the art could modify the embodiments recorded in the forgoing embodiments or equivalently substitute part or all of the technical features thereof. Such modifications or substitutions do not lead to departure of the spirit of the corresponding technical solutions from the scope of claims of the present disclosure.

What is claimed is:

1. A method, comprising:
obtaining content to be displayed, the content comprising a first portion of content having a first display ratio and a second portion of content having a second display ratio;
displaying the first portion of content in a first region of a display unit whilst maintaining the first display ratio of the first portion of content; and
displaying the second portion of content in a second region of the display unit whilst maintaining the second display ratio of the second portion of content.

2. The method of claim 1, wherein the first region and the second region of the display unit do not overlap with each other.

3. The method of claim 2, wherein
a display ratio of the first region of the display unit is the same as the first display ratio of the first portion of content, and
a display ratio of the second region is the same as the second display ratio of the second portion of content.

4. The method of claim 3, wherein the first display ratio of the first portion of content is different from the display ratio of the display unit.

5. The method of claim 4, wherein displaying a first portion of content in a first region of a display unit comprises:
processing the first portion of content if the display ratio of the first portion of content is greater than that of the display unit.

6. The method of claim 5, wherein displaying a first portion of content in a first region of a display unit further comprises:
processing the first portion of content if the display ratio of the first portion of content is smaller than that of the display unit.

7. The method of claim 4, wherein obtaining the content comprises:
obtaining content of a first application; and
using the content of the first application to display the first portion of content.

8. The method of claim 7, wherein obtaining the content further comprises:
determining the second portion of content based on the content the first application.

9. The method of claim 7, wherein obtaining the content further comprises:
determining the second portion of content independent of the first application.

10. An apparatus, comprising:
a processor configured to obtain content to be displayed, the content comprising a first portion of content having a first display ratio and a second portion of content having a second display ratio; and
a display module comprising a plurality of regions to display the content,
wherein the processor is configured to display the first portion of content in a first region of the display module whilst maintaining the first display ratio of the first portion of content, and to display the second portion of content in a second region of the display module whilst maintaining the second display ratio of the second portion of content.

11. The apparatus of claim 10, wherein the first region and the second region of the display module do not overlap with each other.

12. The apparatus of claim 11, wherein
a display ratio of the first region is the same as the first display ratio of the first portion of content,
a display ratio of the second region is the same as the second display ratio of the second portion of content.

13. The apparatus of claim 12, wherein
the first display ratio of the first portion of content is different from the display ratio of the display unit.

14. The apparatus of claim 10, wherein the display module is deformable to provide a different display ratio of the first region or the second region to display the first portion of content or the second portion of content respectively.

15. The apparatus of claim 10, further comprising
a maintenance apparatus that maintains a relative positional relationship between the apparatus and at least one part of a user's body.

16. The apparatus of claim 15, wherein
the maintenance apparatus is operative to maintain the relative positional relationship between the apparatus and the at least one part of a user's body in response to the user wearing the apparatus.

17. The apparatus of claim 16, wherein
the display apparatus is deformable to become arc-shaped.
